(19) United States
(12) Patent Application Publication
(10) Pub. No.: US 2002/0085252 A1
(43) Pub. Date: Jul. 4, 2002

(54) Interleaver filters employing non-birefringent elements

(76) Inventors: Gang Paul Chen, Monterey Park, CA (US); Avishay Eyal, Pasedena, CA (US); Anthony S. Kewitsch, Santa Monica, CA (US); Victor Leyva, Pasedena, CA (US); William K. Marshall, Pasedena, CA (US); George A. Rakuljic, Santa Monica, CA (US); Xiaolin Tong, Irine, CA (US); Xian Li Yeh, Walnut, CA (US); Don Zambos, Santa Monica, CA (US)

Correspondence Address: JONES, TULLAR & COOPER, P.C., P.O. BOX 2266 EADS STATION, ARLINGTON, VA, 22202

(21) Appl. No.: 09/898,469

(22) Filed: Jul. 5, 2001

Related U.S. Application Data
(60) Provisional application No. 60/221,573, filed on Jul. 28, 2000.
(60) Provisional application No. 60/230,142, filed on Sep. 5, 2000.

(51) Int. Cl. H04J 14/06

(52) U.S. Cl. 359/122

(57) ABSTRACT

Interleavers for optical systems, including multiplexers and demultiplexers, are based on the use of non-birefringent elements in combination with polarization beam splitter to provide differential retardation effects for generation of precise transmittance functions. The retardation elements, in one particular example, are non-birefringent glasses arranged in individually athermal stages but the optical beams propagated through them are maintained in selected polarization states in each stage. Between or within the stages the polarization vectors are varied to match phase to a selected standard, such as an ITU grid. Within the stages, selected beam angle adjustments are made to shape the output transmittance characteristic.

### REFERENCE TO RELATED APPLICATIONS

This application relies for priority on provisional application Ser. No. 60/221,573 filed Jul. 28, 2000, and entitled “Design and Fabrication Interleaver Based on Birefringent Interferometers Utilizing Glass Elements” and provisional application Ser. No, 60/230,142 filed Sep. 1, 2000, and entitled “Design and Fabrication Interleaver Filters Based on Birefringent Interferometers Utilizing Glass Elements”.

### FIELD OF THE INVENTION

This invention relates to systems and methods for filtering wavelength multiplexed optical signals and multiplexing or demultiplexing channels by interleaving.

### BACKGROUND OF THE INVENTION

Modern communication systems using optical fibers for dense wavelength division multiplexing (DWDM) applications are being developed with constantly increasing wavelength densities, the channels being spaced apart in accordance with the standardized ITU grid. As the channel spacings are decreased for greater data density, they introduce the problem of achieving ever more precise filtering to maintain signal integrity. To relieve these constraints, those in the art have adopted interleaving techniques. Interleaving systems, usually employing interferometer principles, divide (for demultiplexing) the channels into two or more groups with increased spacings between channels.

When multiplexing, alternating channels on separate waveguides are combined at a single waveguide with the channels interleaved in center frequency. This branching approach minimizes the number of additional components needed for separating or combining channels when upgrading an optical network. For demultiplexing there is the added advantage that less precise individual filter devices can subsequently be used for individual channels.

Interleaver filtering technology is thus now a common solution to provide a scaleable and cost-effective way to double (100 Ghz -50 GHz), quadruple (200 GHz -50 GHz), or further multiply, the available channel count for a given wavelength range in both metropolitan and long-haul DWDM systems. The technology can be advantageously employed in reciprocal fashion, to divide an input DWDM transmission into separate channels or to combine channels into a lesser number of fibers. Two separate mux or demux devices operating at twice the channel spacing are combinable to cover an entire operating window by interleaving them; that is, one mux or demux covers the odd channels while the other covers the even channels.

Interleaver filtering enables devices that perform well only at wider channel spacings (e.g., thin film DWDM filters at 200 GHz) to address narrower spacings (e.g. 50 GHz) w7ithout being required to meet higher performance criteria than would otherwise be imposed by the narrower spacings. Thus, if a network is initially designed for a wide channel spacing, an interleaver can be installed to halve the spacing and increase data capacity. This scaleable approach to increasing bandwidth is of particular interest to the metro/access market, allowing a “pay as you grow” approach and the potential for increased flexibility in optical networking.

The birefringent crystal based polarization interferometer is a common design for interleavers with 100 GHz input channel spacings. Compared to other technologies, such as the unbalanced Mach-Zehnder fiber interferometer, the birefringent crystal design appears to have many potential advantages, such as low insertion loss, compact size, potential for passive temperature compensation and low cost. In theory, one can use a 100 GHz design with passive temperature compensation to make an interleaver with 50 GHz input channel spacing by doubling up the lengths of every birefringent crystal while retaining the passive temperature compensation. However, this birefringent crystal approach is difficult to implement at narrow channel spacings because of crystal cost, inhomogeneity of the material, fabrication challenges and the overall interleaver dimensions. For example, interleaver components in this class are based on multiple stages of birefringent crystals, which introduce retardations between differently polarized signals that are used to establish the interleaving optical transfer function. To meet the performance requirements of modern DWDM systems, these designs require high quality crystalline materials with high birefringence, low material dispersion, high index of refraction homogeneity and linear optical path length variation with temperature. Control of these parameters is difficult to achieve in crystals, due to the limited selection of suitable materials, the relative difficulty in growing such materials, and the often significant differences between the characteristics of successive production runs. Crystals are grown in small boules which do not remain uniform from boule to boule, resulting in frequent modifications of the design lengths based on crystal lot number. Examples of typical birefringent crystals are YVO₄, rutile, calcite, LiNbO₃, TeO₂, and BBO. Crystals also typically exhibit anisotropies in the mechanical, thermal, optical, and electrical properties which may complicate their use. As a consequence, crystal based interleavers suffer from inconsistencies in the index of refraction, birefringence, absorption and thermal characteristics. They can also be more fragile under shock or vibration. Phenomena such as the pyroelectric effect introduce additional temperature dependencies which must be compensated for in crystal based designs.

On the other hand, optical glasses are available in much greater quantities and varieties, and with much higher material consistency than birefringent crystals. Standard glasses from Ohara, Schott, Corning, Heraus and Hoya are readily available and well suited for applications in which dispersion, refractive index and length are precisely predictable. Therefore, an interleaver design utilizing glass materials would have distinct advantages over a crystal based interleaver from a manufacturability and performance point of view.

Polarization interferometers using crystal rather than glass elements have been utilized as bandpass optical filters for astronomy applications as disclosed by Evans et. al., Journal of Optical Society of America, Vol. 39, No. 3 1949. use of glass elements in a modulator was proposed by G. P. Katys et. al., “Modulation and Deflection of Optical Radiation,” 1967. The bandpass filters have had little direct value for telecommunications applications, however, because they simply throw away off-band power rather than capture it in a useful manner. Also, they are transmission filters, rather than wavelength selective splitters or combiners. However, they demonstrate that polarization interferometric principles can be of potential applicability to the demands of interleaving systems. Apart from this partial conceptual similarity, however, there is no basis for assuming that the stringent optical performance requirements and conflicting performance parameters of modern optical network systems can be satisfied in the ways required. For example, the interleaver should be polarization insensitive, and should essentially be athermal over a range of 70° C. or more, or affected only to a negligible extent by variations in temperature. Polarization mode dispersion (PMD) and chromatic dispersion (CD), together with channel walk-off (variations in performance near the limits of the frequency band) must be kept under control. Also, bandpass channels must be precisely placed relative to the ITU grid specifications, the transmissivity function should approximate a modified square wave to the extent possible, crosstalk between channels must be low, and insertion losses should be negligible. Most importantly from a practical standpoint, the device must be designed in a manner which facilitates volume manufacture. The present disclosure provides theory and practical implementations which satisfy such needs.

### SUMMARY OF THE INVENTION

In accordance with the present invention, the optical retardation characteristics of non-birefringent assemblies are employed in unique combinations to provide compact, high optical performance, stable and manufacturable interleaving optical filters for DWDM. The effects used can be said to be based on a principle of synthetic birefringence. Micro-optic based glass and/or air delay lines are disposed in stages between polarization beam splitters which are used to establish varying polarization states while the stages separate and combine beams with not only differential retardation, but also frequency period tuning and phase tuning. The interleavers accept inputs with arbitrary states of polarization and concurrently establish the desired athermal, low loss, low crosstalk, low PMD, low CD, low passband ripple, and wide passband width characteristics. In addition, the practical implementations are such that the desired characteristics for a range of products can be achieved using modular and production oriented techniques.

In a general example, an interleaver for demultiplexing or multiplexing multiple DWDM channels comprises at least one stage in which separate and optically parallel non-birefringent optical delay lines propagate different polarization components at like velocities but over different optical path lengths. For demultiplexing at a given channel spacing, say 50 GHz, for example, a wavelength channel is split into two pairs of beams, closely spaced (e.g. 700 mm) in orthogonal directions. The separate beams of each pair are orthogonally polarized, but optical path lengths, not propagation velocity, introduce differential retardation. Advantageously, athermal responsiveness is established, using the glass elements of a stage, by interrelating indices of refraction, thermooptic characteristics and delay line lengths such that, over a selected temperature range, there is a precise and relatively constant differential retardation. By using waveplate adjustments within or subsequent to stages, the phase of the transmissive peaks can be tuned to correspond precisely to the target values in an ITU grid.

The stages provide outputs with wavelength dependent states of polarization, but after the final stage (for a demultiplexer) these states are decoded by beam displacing polarizers, to generate two frequency dependent transmissive outputs, one of odd channels and the other of even channels, each being polarization independent. Conversely, separate odd and even channel inputs to these two terminals will result in multiplexing the two sets of channels together at the opposite single terminal.

When two or more stages are used in series, each is configured to have like athermal properties, and to include polarizing beam splitters and waveplate arrays which produce wavelength dependent states of polarization. For the next stage, the beams are again split into two beam pairs with orthogonal polarization. The successive stages are configured with lengths and angles of polarization which cumulatively shape the passbands to, for example, square wave approximations having excellent inter-channel rejection.

In accordance with another feature of the invention, the non-birefringent optical delay lines may comprise selected length air paths, formed by an etalon, a multiple mirror system or a nonlinear loop mirror. Proper compensation is introduced for path length variations with temperature, but chromatic dispersion is not a factor. Dispersion effects become increasingly more troublesome, unless corrected, as channel spacing is reduced. By using appropriate polarization rotation between the filtering stages or within the phase tuning elements, the group delay response can be inverted in an interleaver. This enables a serial mux/demux pair in accordance with the invention to have matched quadratic up and quadratic down characteristics so as to produce zero net chromatic dispersion.

One stage, two stage and three stage designs are disclosed using different polarization angles and relationships for different ITU grid requirements, including 50 GHz, 25 GHz and 12.5 GHz spacings. In each, waveplate combinations between in the beam paths are configured to provide extremely precise phase tuning, and polarizing beam splitters can be angled to adjust frequency periodicity. Different delay line expedients are utilized to eliminate any non-uniformities due to air path length variations from air gaps and beam displacement devices. A properly oriented linear polarizer may be employed to improve contrast and reduce PMD to lower levels. In accordance with other features of the invention, the waveplate array combinations which are employed between stages adjust the angles of circularly polarized beam pairs of chosen orthogonalities before the individual beams are recombined and again redivided with different polarization vectors for the next stage. Power decoding of beams with wavelength dependent states of polarization after the last stage of a sequence is effected by adjustment of the polarization states of the combined beams before resplitting by a polarization beam splitter, realignment of the polarization angles, followed by recombination with another polarization beam splitter to provide a pair of beams that are intensity modulated and carry the odd and even channels, respectively. These configurations are particularly suited for high yield, high volume manufacture. Glass elements of assuredly uniform characteristics and physical lengths L can be disposed in integer multiples, chosen for each stage. Furthermore, the glass elements and intervening waveplate arrays can be mounted on a planar base along a longitudinal axis, so that they do not require individual adjustments for proper angle, any such adjustments being made by waveplates between the stages. With closely spaced beams and glasses of substantially different refractive indices, compact multi-stage interleavers meeting stringent performance requirements are provided.

### BRIEF DESCRIPTION OF THE DRAWINGS

A better understanding of the invention may be had by reference to the following description, in conjunction with the accompanying drawings, in which:

FIG. 1 is a perspective view of the configuration of an interleaver based upon synthetic birefringence in accordance with the invention;

FIG. 2 is a schematic top view of the interleaver of FIG. 1, depicting the beam paths through the interleaver from one angle, and indicating the various waveplate angles therealong.

FIG. 3 is a schematic side view of the interleaver of FIG. 1, with beam paths depicted from a second, different angle, and also indicating angles of inclination of polarization vectors and states of polarization of ordinary and extraordinary beams;

FIG. 4 is an enlarged perspective of a waveplate combination useful in the configuration of FIGS. 1-3;

FIG. 5 is a simplified schematic perspective of the array of FIG. 4, showing diagrammatically how phase tuning is effected through the elements therein;

FIG. 6 is an enlarged fragmentary perspective of an output decoder power combiner employed in the configuration of FIGS. 1-3, and including diagrammatic representations of the changing positions of ordinary and extraordinary beams therein;

FIG. 7 is a group of waveforms illustrating the individual cumulative effects of second and third stages on the transmission characteristics of a three stage interleaver in accordance with the invention;

FIG. 8 shows two waveforms illustrating the calculated optical responses of even and odd channel outputs of a 50 GHz interleaver;

FIG. 9 is a simplified perspective view of a 50 GHz interleaver in which beams in the optical delay lines are propagated in circular states of polarization;

FIG. 10 is a perspective view of a two stage, highly developed example of a 25 GHz interleaver meeting stringent optical and thermal performance specifications;

FIG. 11 illustrates typical interleaver transmission characteristics for one output of 100, 50, and 25 GHz interleavers;

FIG. 12 is a perspective view of a three stage, highly developed example of a 25 GHz interleaver meeting stringent optical and thermal performance specifications;

FIG. 13 is a perspective view of a two stage, highly developed example of a 12.5 GHz interleaver meeting stringent optical and thermal performance specifications;

FIG. 14 is a simplified block diagram of a tunable dispersion compensator using two interleavers having cancelling group delay characteristics;

FIG. 15 is a schematic diagram of a system employing an interleaver-based 50 GHz multiplexer and an interleaver-based 50 GHz demultiplexer with canceling group delay characteristics for even and odd channels;

FIG. 16 is a graph of the calculated group delay for two interleaver outputs, each output transmitting the even or odd channels and exhibiting different group delays with frequency;

FIG. 17 is a graph of calculated chromatic dispersion characteristics for two interleaver outputs, each output transmitting the even or odd channels and exhibiting chromatic dispersion of opposite signs;

FIG. 18 shows chromatic dispersion characteristics as measured for two channels of a type 150 GHz interleaver;

FIG. 19 shows chromatic dispersion characteristics as measured for two channels of a type 125 GHz interleaver;

FIG. 20 is a simplified representation of a synthetic birefringent interleaver filtering stage utilizing an air delay line;

FIG. 21 is a side view of a monolithic air delay element using optically contacted mirror surfaces;

FIG. 22 is a diagrammatic representation of the components and the evolution of the state of polarization in a single time delay element which includes a nonlinear loop mirror to achieve crosstalk reduction and passband flattening; and

FIG. 23 is a top view of a single stage athermal time delay element using three different glasses.

### DETAILED DESCRIPTION OF THE INVENTION

Interleavers based upon differential retardation or time delays function in ways which are not readily translatable from the classical techniques used in polarization interferometers for astronomy applications. Interleavers must meet stringent requirements having no counterparts in such interferometers, by introducing complex optical transfer functions to each of a multiplicity of wavelength signals in the same densely multiplexed optical beam. In doing so, the interleaver must establish precisely placed transmittance bands that approximate square wave shapes to the extent possible and match the locations of target frequencies to the channel spacings of the ITU grid. For example, the precision required for absolute phase is +/−1 GHz, and for frequency periodicity the precision required is +/−50 MHz. Meeting such requirements while concurrently providing a system which is insensitive to the polarization characteristics of input signals, and which introduces minimal loss, minimal channel walk-off and provides high channel isolation while operating athermally over an extended temperature range involves numerous interacting factors which have not heretofore been achieved in an interleaver. Moreover, meeting such performance characteristics will clearly be of limited or no practical value unless economic benefits are also obtained, in terms of material and labor costs, reproducibility and yield. Interleavers are utilized for both multiplexing and demultiplexing functions, so it is important that a given unit be operable for both purposes with only minimum adaptation. It will be appreciated that the description below, while using examples that are primarily concerned with demultiplexing, is applicable as well to the use of the same structures and relationships for multiplexing.

The following example of a practical three stage, 50 GHz interleaver for demultiplexing shows that the foregoing performance specifications, and more, are met by manipulation and transformation of polarization states in non-birefringent differential retardation stages, together with interspersed frequency period tuning expedients and phase tuning elements, and polarization sensitive beam splitters. Those skilled in the art will recognize that birefringent crystals may be used in a non-birefringent manner, by orientation of the crystal axis to beam polarization. This, of course, would be at the expense from the cost, availability and uniformity problems mentioned above.

50 GHz Three Stage Interleaver

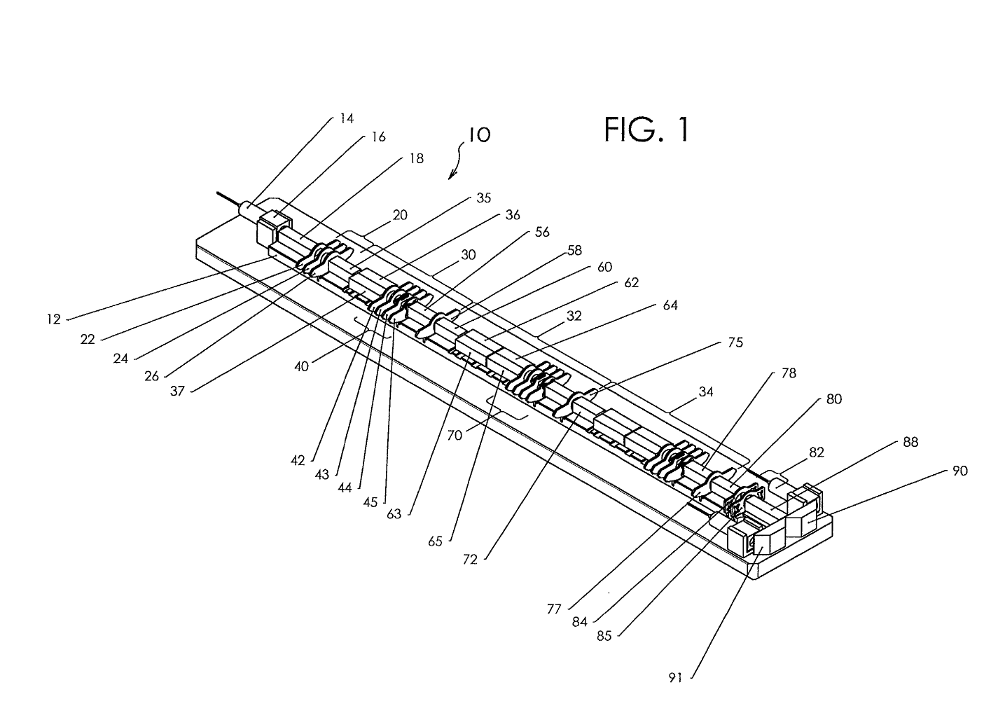

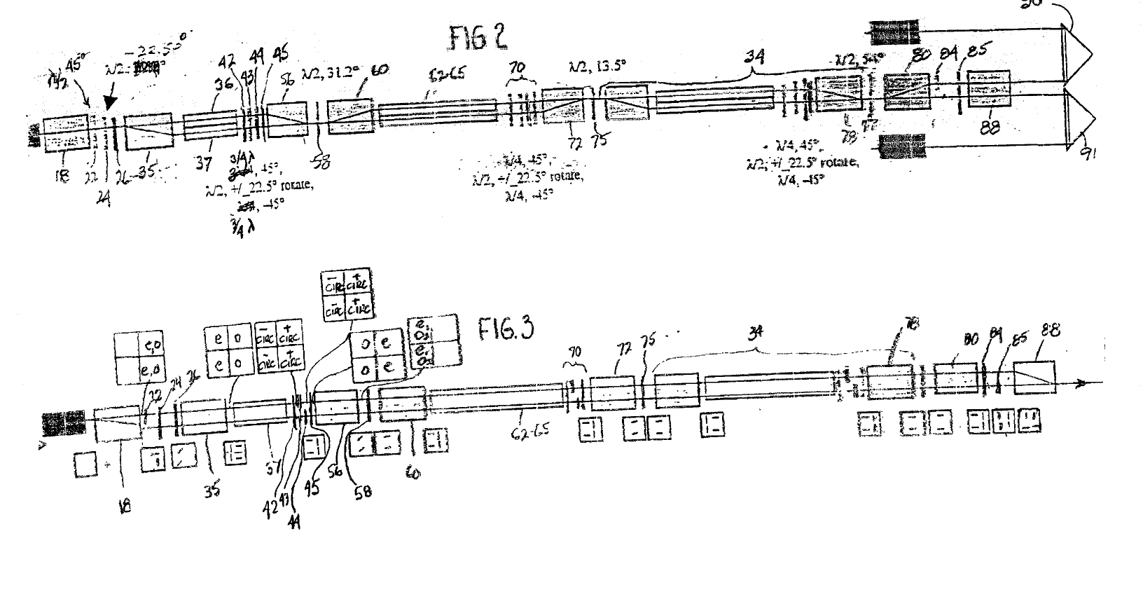

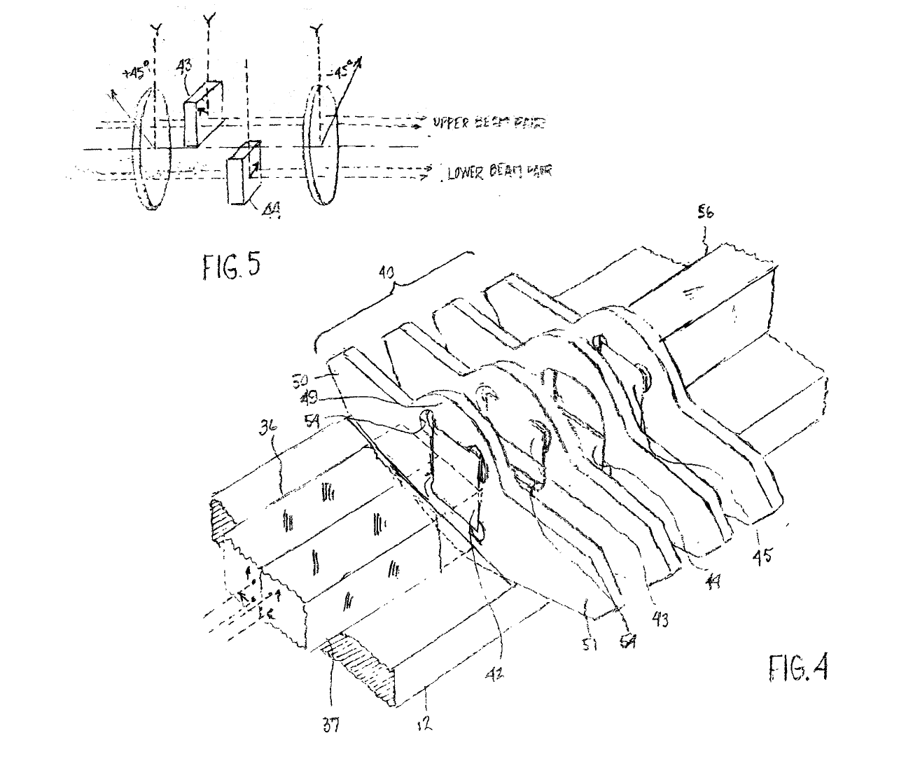

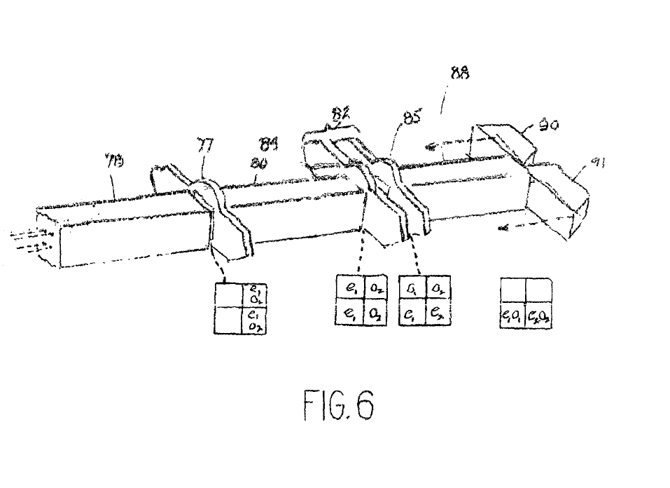

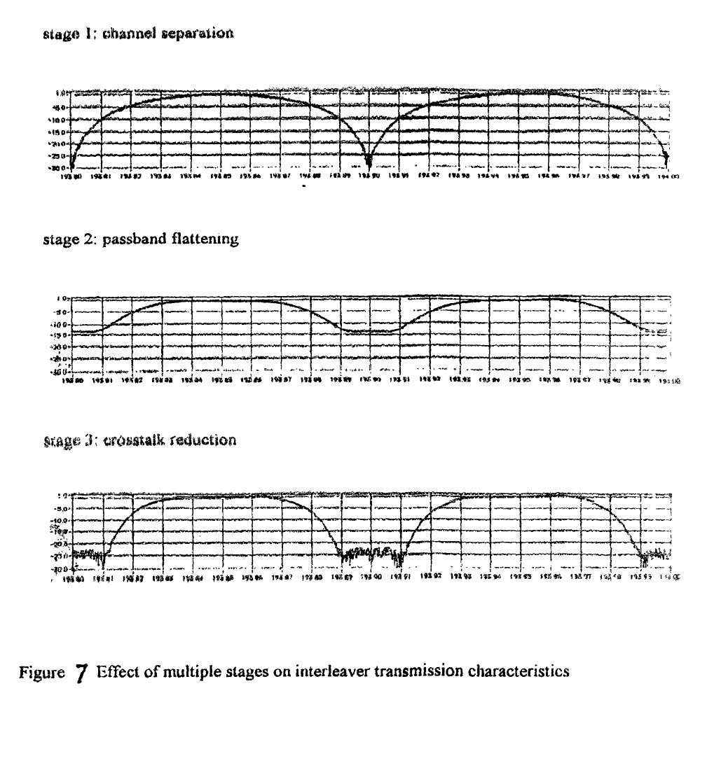

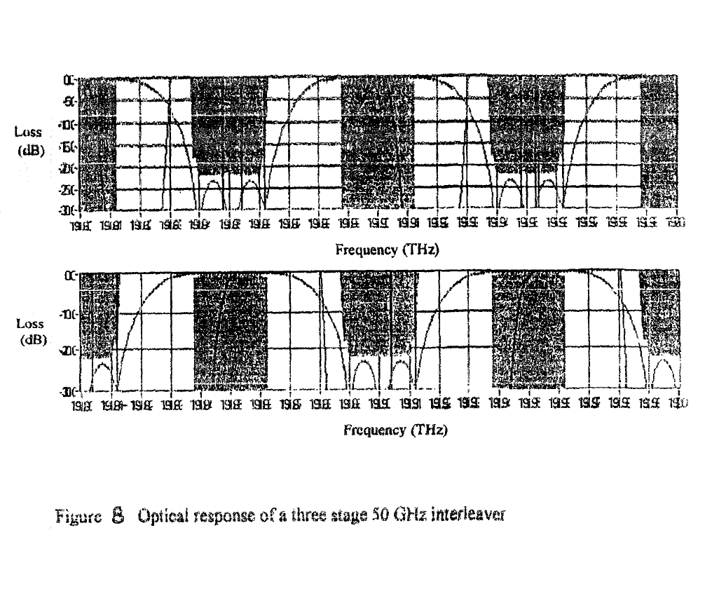

FIGS. 1-3 illustrate a particular example of a 50 GHz athermal and polarization independent interleaver meeting very stringent performance characteristics. FIGS. 4 and 5 show further details of waveplate combinations used in the device and FIG. 6 depicts aspects of the elements for deriving intensity modulated signals after the last stage. This interleaver is based on a two glass, three stage design with substantially like lengths of different glass in the two arms of a stage. These lengths can be made equal but usually at the expense of requiring precise index of refraction characteristics which may not be readily available. The interleaver microoptic assembly 10 comprises multiple microoptic elements serially mounted along a central reference axis on a bench or support plane 12 (FIG. 1), in such fashion that the individual elements are substantially free to expand and contract longitudinally with temperature changes. The example shown is a demultiplexer but essentially the same configuration can serve as a multiplexer with inputs and outputs reversed. Multi-channel DWDM signals in an input optical beam with an arbitrary state of polarization and spaced in accordance with chosen frequency locations in the ITU grid are delivered via a single mode optical fiber 14 through an input collimator 16 to a succession of, for example, three non-birefringent filter stages. Independence of the initial state of polarization (SOP) is achieved by first separating the input optical beam into two optical beams with orthogonal polarizations at an input polarization beam splitter 18. The function of splitting beams to provide different polarizations and beam displacements can be effected by a number of known different expedients, such as “polarization splitters”, “polarization splitting cubes”, “beam displacing polarizers”, “beam splitter/polarizers”, and “pbds”. Here these terms are to be regarded as interchangeable and encompassed within “polarization beam splitter”. Birefringent crystals, here of YVO₄, are employed in this instance for the polarization beam splitters. The two orthogonally polarized upper and lower beams, each with extraordinary (e) and ordinary (o) components, are in parallel paths, separated in the vertical direction by approximately 0.7 to 1.0 mm. The vertical separation is indicated schematically in FIG. 3, which also includes separate polarization state diagrams at successive transformation points along the length of the assembly. The more detailed view of FIG. 6 includes polarization state diagrams at the output power decoder elements, while FIG. 2 designates waveplates and waveplate angles along the propagation path.

After the input beam splitter 18, the vectors of the two polarized components are then reoriented in a first waveplate combination 20, in which the upper beam alone first passes through a half waveplate 22 oriented at 45° to rotate the polarization by 90°. The polarization reference frame used here is one in which 0° is defined as vertical and positive angles are defined as clockwise. Then both identically polarized beams pass through a half waveplate 24 at −22.5° to the vertical axis. Upon exiting this first waveplate combination 20, both beams are identically linearly polarized at an angle of 45° relative to the vertical axis. To further ensure that these beams are linearly polarized to the necessary extinction level, they may next pass through a polarizing plate 26 also oriented at 45° which establishes a polarization reference angle. The group delay characteristics for the even and odd channels, in terms of whether the group delays are quadratic up or quadratic down, are dependent on whether the input linearly polarized beams are oriented at 45° or −45°. That is, the group delay exhibits a local maximum or minimum at the ITU channel centers, and either increases or decreases quadratically about the channel centers within the frequency extent of the transmission passband (e.g., 10 or 20 GHz in width). The group delay characteristics are further influenced by the phase relationships between the stages established during phase tuning.

The beams next pass through the first retardation stage 30 of the 50 GHz interleaver, with the retardation differential characteristic of birefringence being synthesized by two glass elements chosen for 100 GHz spacing, each with nominal physical length L which provides an optical path length difference Δ/ arising from their different indices of refraction. Successive retardation stages 32, 34 are serially disposed along the longitudinal axis after the first stage 50, but for 50 GHz spacing have double the optical path length difference i.e., total optical path length differences of 2 Δ/ in this instance. As is discussed below it is advantageous to use glass elements of standard length L, and to array a set of these in series, with n in number for a stage, where n is an integer multiple, i.e. 1, 2, 4, 8, etc. the differential path lengths will then be nΔ/. The difference in optical path lengths Δ/ is proportional to

$$\frac{c}{Δ f} ,$$

where

Δf is the desired frequency period of the optical transmission response. Keeping D/variations to less than 1 part in 10⁴ is preferred.

More specifically, at the first stage 30 input, a second polarization beam splitter 35 separates each of the two upper and lower input beams into additional e and o polarized beams, horizontally separated by about 0.7 mm (700 mm), as schematically indicated in the top view of FIG. 2. In passing through the second polarization beam splitter 35 the e and o beams, upper and lower, are orthogonally polarized (FIG. 3). The two e and o beam pairs then pass through a pair of adjacent glass delay line elements 36, 37 to provide the chosen optical path length difference D/. The lengths of the glasses are selected to take into consideration the indices of refraction, the thermooptic coefficients, and the thermal expansion coefficients, to maintain a virtually constant optical path length difference over a selected temperature range (e.g. −5° C. to +55° C.) and achieve passive athermal performance. In accordance with analyses given in detail below, the physical lengths L of the paired delay line elements can be equalized if desired, but practical designs more often will settle on the use of physical lengths which are nominally the same but differ by less than 10%. The glass elements 36, 37 can be of substantially different indices of refraction, such that the beams which exit the glass delay lines traverse optical path lengths differences D/ approximately equal to half of the physical lengths L of the elements.

In general terms (controlling equations are given below), if the unbalanced air path is kept small enough so that the temperature drift caused by air is within a design margin, each stage can use only two parallel glass pieces closely matched in length, one for each e and o beam pair, and satisfy the controlling equations simultaneously. In practice, it is preferred to keep the differential air path length below 200 microns to maintain athermal performance characteristics in a 100 GHz periodicity stage, with an approximate total limit of 600 microns for all stages. There are several criteria to select suitable glass material for the two glass design. First, to minimize the length of the interleaver, the two glasses should preferably have as large an index of refraction difference as possible, and generally at least 15% difference. Typical high index glasses have an index of 1.9, and low index glasses have an index of 1.4. Second, the two glass elements will preferably be closely matched in length. This demands that the change in optical path length with temperature for both glasses be equal, so that the interleaver stages are athermal. The optical path length temperature dependence includes a contribution from physical dimension (thermal expansion) and from the index change with temperature (thermooptic). When all the controlling factors are properly interrelated these conditions can be readily met from a variety of glasses supplied by Schott, Ohara, and Hoya.

At the input to the first stage 30, the input beams have been split into the upper and lower e, o beam pairs (as seen in FIG. 3 particularly) by the polarization beam splitter 35. The beams retain their states of polarization as the e beams pass through the left delay line 36 and the o beams pass through the right delay line 37. The beams enter a waveplate combination 40 serving as a phase shifter or tuner, shown in greater detail in FIGS. 4 and 5, consisting of a ¼ or ¾ waveplate 42 oriented at 45°, an upper ½ waveplate 43 oriented at a variable angle f₁, a lower ½ waveplate 44 oriented at a variable angle f₂, and another ¼ or ¾ waveplate 45 oriented at −45°. The first ¼ waveplate 42 converts the linear polarization to a circular state of polarization, and the ½ waveplates 43, 44 shift the phase of the upper and lower beam pairs independently and by the desired amounts, before the second 34 waveplate returns the beams to a linear polarization state. To align the response in phase to the absolute ITU frequency grid, the ½ waveplates 43 and 44 are individually rotated in transverse grooves 48 in the bench 12, typically using an optical spectrum analyzer to measure the interleaver response before fixing the waveplates in place. Separate adjustments within as much as a 45° range vary the frequency response of the upper and lower beam pairs, respectively, to coincide with the ITU grid to within 1 GHz or 2p/100 radians. The lengths of the glass delay elements are precisely controlled to give a frequency period of 100.00±0.01 GHz or, in general, a period equal to twice that of the input channel spacing.

As seen in the perspective of FIG. 4 and schematic of FIG. 5, in the second waveplate combination 40 each different waveplate 42-45 is mounted in a flat or planar short central body 49 that fits into the associated transverse groove 48 holder on the optical bench 12. Side wings 51, 52 enable easy rotational manipulation of the waveplate angle. The active optical element, e.g. the ¼ or ¾ waveplate 42, is set into a central aperture 54 in the body 49. In this instance the first ¾ waveplate, as seen in FIG. 5, converts the linear polarizations of the input beams to circularly polarized beams of opposite senses so that the right beams have positive directions of circulation and the left beams have negative directions of circulation (FIG. 3). The states of polarization of the upper and lower beam pairs are then selectively and separately transformed by the ½ waveplates 42, 43 which respectively span the upper beams only and the lower beams only. Separate transformation is necessary because the practical limitations on parallelism dictate that the upper and lower beams be separately phase tuned. The open parts of the apertures 54 in these ½ waveplates 42, 43 permit unoccluded passage of the unaffected upper or lower beam pair. The last waveplate in the second combination is another ¾ waveplate 45 to return the beams from circular to linear polarization, with the fast axis at a relative angle of 90° to the first ¾ waveplate 42. The four beams, two left ordinary (o) and two right extraordinary (e) beams are thereafter combined by a polarization beam splitter 56 into upper and lower left beams having both e1 and o2 components, as shown in the polarization diagram at this point in FIG. 3.

It should be noted that the angle of the fast axis of the first ¾ waveplate 42 can be plus 45° or minus 45° relative to the vertical direction, and that the second ¾ waveplate 45 is oriented at an angle of like amplitude and opposite sign.

The beams which exit the first phase shifter 40 have polarizations rotated by 90° relative to the inputs to the optical delay lines 36, 37, as seen in the polarization vector diagrams of FIG. 3. When recombined by a polarization beam splitter 56 into two beams, the beam which originally passed straight through the input polarization beam splitter 18 is displaced in the output polarization beam splitter 56, and the beam displaced by the polarization beam splitter 35 passes straight through the output polarization beam splitter 56. The lengths of the splitter 35 which divides and the splitter 56 which combines are precisely matched (e.g. to within 250 microns) to ensure that the split beams are recombined into a single spot, that the distance each beam travels within the pair of beam splitters is the same and that any temperature dependency arising from the beam splitters is eliminated.

Upon exiting the first stage 30 of the three filtering stages, the two beams each now include both e and o polarization components, as indicated by the adjacent polarization array diagram of FIG. 3. The e polarization contains only the odd wavelength channels (hence the e₁ designation), and the o polarization contains only the even wavelength channels (O₂ designation). These combinations provide wavelength dependent states of polarization that would have to be decoded for intensity modulation, but instead are transferred into the next filtering stage, for purposes of synthesizing more accurately the desired transfer function.

Between each pair of stages, an interstage waveplate, such as a waveplate 58 after the combining polarization beam splitter 56, is mounted at an angle selected to synthesize the desired frequency response of the interleaver and contribute to the desired optical transfer function. In most interleaver applications, a flat top or approximately square aspect ratio in the interleaver transmission passband is desired. The flattening is achieved by the cascading of the additional flattening stages that have Δf=Δf/2 and/or Δf=Δf/4, oriented at different relative angles between each stage. The relative angles of the waveplates dictate the resulting passband flatness, stopband rejection and chromatic dispersion. We have selected a set of waveplate angles which achieve a filter response close to that of an ideal square wave response. Here the first response shaping waveplate is a ½ waveplate 58 at 31.2°.

In manipulating the optical beams, the optical system makes use of a complex evolution of the states of polarization passing through the non-birefringent microoptic delay elements, and the polarization sensitive beam dividers and combiners. Although a 50 GHz interleaver is disclosed in FIGS. 1-6, the same concepts apply equally well to any channel spacing as evidenced by the other examples herein. Referring briefly to FIGS. 1-3 relative to the second stage 32, a polarizing beam splitter 60 splits the angle-adjusted upper and lower beams into four beams closely spaced, and of linear polarization in orthogonal left and right pairs for the succeeding delay lines. Here the orthogonality is reversed, relative to the input to the first stage. Also, to provide delay lines of nominal differential length 2D/, two individual pairs of differential length D/ are serially disposed in the left and right beam paths. The athermal characteristic is maintained by proper pairing of the left and right glass elements 62, 63 and 64, 65 respectively, in accordance with the controlling equations. After phase tuning in another four-element waveplate combination 70, the beams are recombined into two by a polarizing beam splitter 72. Another interstage ½ waveplate 75, oriented here at 13.5°, is set to further shape the transmission response.

The third filtering stage 34 is repetitive of the second stage 32, except that the final response shaping ½ waveplate 77 is at an angle of 54°. The relative orthogonalities of the beams in the delay lines are again reversed from the immediately prior stage. After each of the second and third stages the optical beams again have wavelength dependent states of polarization.

Following the third stage 34 of the interleaver, two vertically displaced beams after combination from four exit the last beam splitter 70, as also seen in the enlarged perspective of FIG. 6. The e₁ and O₂ beams from the third stage 34 are resplit after polarization rotation by a polarization beam splitter 80 and converted into o₁ and e₂ beams by a two waveplate combination 82 in which different pairs of the four beams travel separately through ½ waveplates 84 and 85 oriented at 45°. The first ½ waveplate 82 spans the right (O₂) beams, without occluding the left (e₁) beams, while the second ½ waveplate spans the lower beams (now e₁ and e₂) without occluding the upper beams (now o₁ and o₂). In consequence, the odd and even ordinary and extraordinary beams are reconfigured for input to a vertical polarization beam splitter 88, with o₁ and e₁ being on the left side and o₂ and e₂ being on the right side (in the diagrams of FIGS. 2 and 6). Therefore, by vertically combining the two left beams into a single output, and the two right beams into a single output via the vertical polarization beam splitter 80, the even and odd channels have been separated from each other, each independent of the input SOP, because they contain both e and o polarizations. The polarization dependent loss is extremely low because the optical paths for the e and o polarization experience the same optical losses.

The two beams are next reflected backwards by a pair of prisms 90, 91 and are directed separately into different ones of a pair of output collimators 93, 94. One output fiber 97 then carries all the odd numbered input frequency channels, and the other 98 carries all the even numbered input frequency channels. The two outputs have been decoded from the wavelength dependent states of polarization of the last stage into intensity modulated, wavelength dependent beams of alternating transmissivity and at twice the periodicity of the input beam.

The 50 GHz interleaver assembly of FIG. 1, which in use includes a hermetically sealed housing (not shown), uses beam splitters of lengths from 6-10 mm, and has a compact total length of less than 15 cm. The individual glass elements can be longer (e.g. up to 20 mm) but total length is an important limitation for most uses, and it is preferred to use glasses such that the individual elements are in the 8-16 mm range.

The microoptic elements may be tilted by >10 arcmin relative to the input beam to provide enough angular and spatial walkoff to prevent reflections from coupling back into the input or output fibers. This provides a return loss of >45 dB without the addition of built-in isolators. The attenuation of the reflection contributions at the throughput ensures that the passband, CD, and PMD ripple in the passband are dramatically reduced.

Conceptual Analysis

The Jones matrix formulation for polarization optics is applied in order to analyze the device. This formulation also enables one to describe the PMD of the interleaver, and is the basis upon which the PMD has been reduced to an acceptable level in practical examples. According to Jones notation, a monochromatic electric field is described by a two element complex vector:

\vec{Ε}=[Εₓe^{lφx}Ε_{y}e^{iφy}]^{T}, where Eₓ and φₓ are respectively the amplitude and the phase of the x component of the electric field, E_{y} and φ_{y} defined similarly and denotes vector transposition. The time dependence of the field is given by: Re{\vec{Ε}^{iat}}, where ω is the optical frequency. The state of polarization (SOP) of the field is completely defined by the ratio:

$$χ = \frac{{E}_{y} {e}^{{iϕ}_{y}}}{{E}_{x} {e}^{{iϕ}_{x}}} \qquad ( 1 )$$

Thus the Jones vector can be written as:

$$\vec{E} ≡ {Ee}^{j \overline{ϕ}} \hat{ϵ} where \hat{ϵ} ≡ \frac{1}{\sqrt{1 + {\vert χ \vert}^{2}}} [ \begin{matrix}1 \\ χ\end{matrix} ] \qquad ( 2 )$$

Where

Εand \overline{φ} are respectively the amplitude and the common phase of the field and \hat{ε} is a unit Jones vector. The Jones matrix, T, of a given transmission-medium is a transformation matrix that describes the relation between the input electric field and the output electric field. Let \vec{Ε}=[Εₗₙ^{x}Εₗₙ^{y}]^{T} describe the field at the input of the medium. Then the output field is given by:

$${\vec{E}}_{out} = [ \begin{matrix}{E}_{out}^{x} \\ {E}_{out}^{y}\end{matrix} ] = T {\vec{E}}_{i n} \qquad ( 3 )$$

A lossless medium is described by a unitary Jones matrix with the following form:

$$T = [ \begin{matrix}a & b \\ - {b}^{*} & {a}^{*}\end{matrix} ] where {\vert a \vert}^{2} + {\vert b \vert}^{2} = 1 \qquad ( 4 )$$

The input field to the interleaver is first split by the input beam splitter. The two beams we obtain are described by:

$${\vec{E}}_{A} = [ \begin{matrix}{E}_{i n}^{x} \\ 0\end{matrix} ] and {\vec{E}}_{B} = [ \begin{matrix}0 \\ {E}_{i n}^{y}\end{matrix} ] \qquad ( 5 )$$

After propagation through the cascaded crystals:

$${\vec{E}}_{A} = {E}_{in}^{x} [ \begin{matrix}a \\ - {b}^{*}\end{matrix} ] and {\vec{E}}_{B} = {E}_{i n}^{y} [ \begin{matrix}b \\ {a}^{*}\end{matrix} ] \qquad ( 6 )$$

After splitting and recombining the suitable components of \vec{Ε}_{A} and \vec{Ε}_{B}, we obtain the interleaver outputs:

$${\vec{E}}_{out 1} = [ \begin{matrix}{E}_{i n}^{x} a \\ {E}_{i n}^{y} {a}^{*}\end{matrix} ] and {\vec{E}}_{out 2} = [ \begin{matrix}{E}_{i n}^{y} b \\ - {E}_{i n}^{x} {b}^{*}\end{matrix} ] \qquad ( 7 )$$

The origin of PMD in the device is mathematically derived from Eq. (7). To demonstrate this we consider two extreme cases. In the first case the input light is linearly polarized and aligned with the x-axis. In that case the output field at port 1 will also be linearly polarized and aligned with the x-axis and its complex amplitude will be

Εₗₙa. On the other hand, if the input field is linearly polarized and aligned with the y-axis, the output in port 1 will be aligned with the y-axis and with a complex amplitude Εₗₙa*. The group delay experienced by the field is given by the derivative of its complex amplitude at the output with respect to the optical frequency, ω. Accordingly, the group delay difference between an x-polarized input and a y-polarized input is proportioned to d[arg(a)−arg(a*)]/dω which in general will differ from zero.

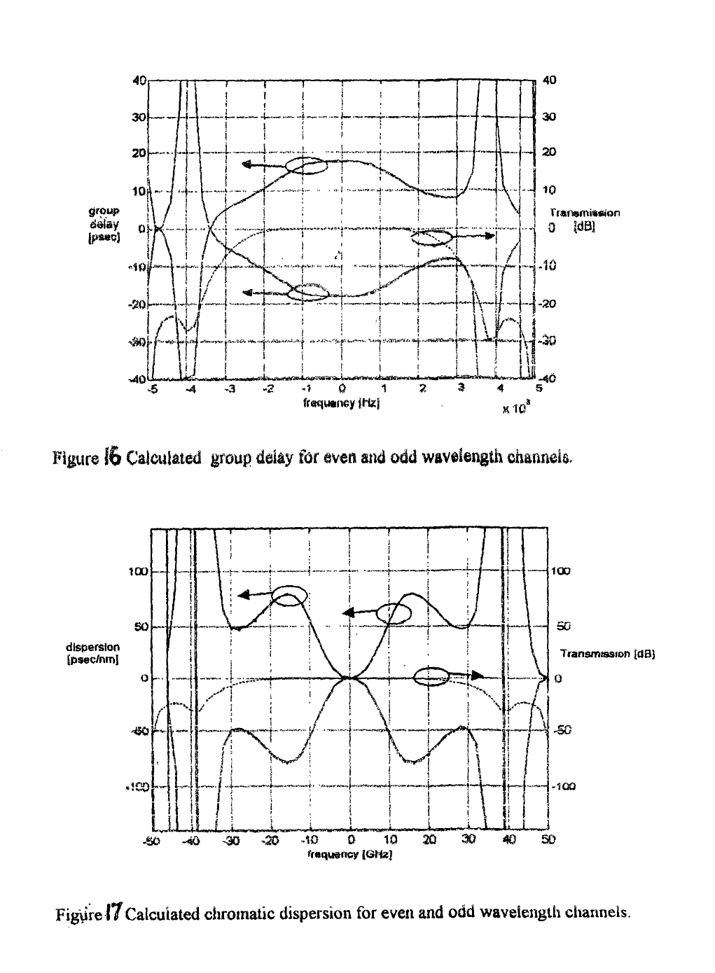

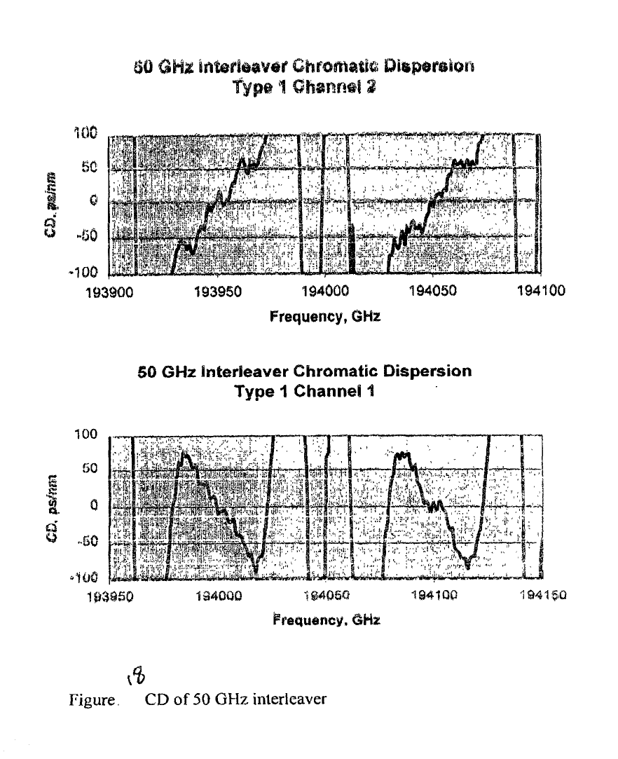

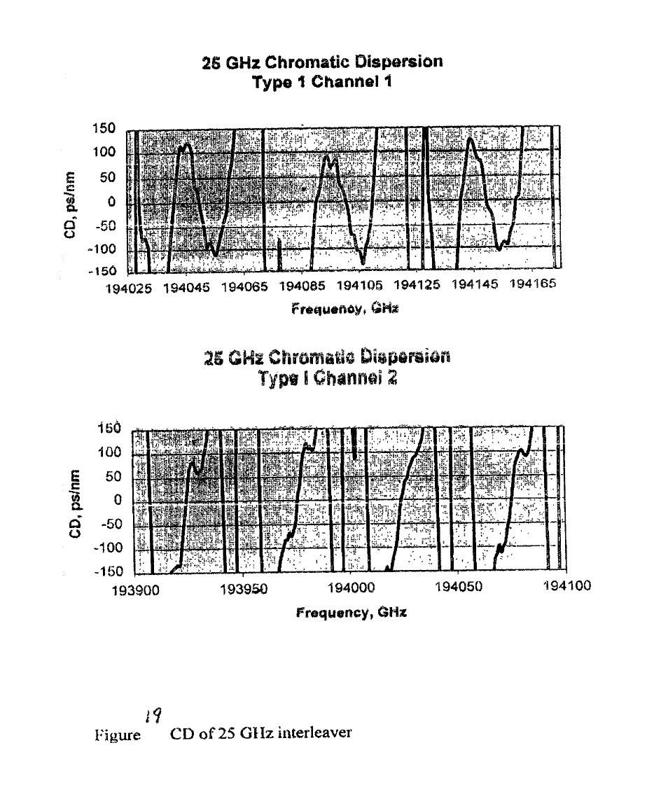

In addition to PMD, another dispersive effect present in optical filters is chromatic dispersion, which results from the wavelength dependent variation of group delay. The group delay response for the even or odd channels of a three stage cascaded filter is depicted in FIG. 16 and the corresponding chromatic dispersion for the even or odd channels is depicted in FIG. 17. Note that the sign of the CD is different for the even and odd channels. As described below, the relative signs can be taken advantage of to produce a true zero CD, zero dispersion slope interleaver pair. The CD of operational prototypes has been measured and is well behaved. The measured CD for both an individual type 1 50 GHz and 25 GHz interleaver are illustrated in FIGS. 18 and 19, respectively. Type 2 interleavers would have chromatic dispersion of the opposite dispersion slope. The combination of a type 1 and type 2 interleaver pair give theoretically zero chromatic dispersion. This control and characterization of CD is essential to designing an interleaver that meets the sub 20 ps/nm CD specification per pair or individual component.

Passive Athermal Design

From a manufacturability point of view it is desirable to minimize the number of microoptic elements assembled into the interleaver. In the simplest embodiment, a glass interleaver stage would be one glass element in the first beam path and air in the second beam path. An example of glass suitable for this embodiment is S-FPL51 from Ohara glass. While this configuration achieves a certain level of passive temperature compensation (3×10⁻²GHz/° C.), further improvement is achieved by reducing the residual optical path length temperature dependence on air. One method to maintain adequate temperature stability is to seal the package so that no leaks are present. This maintains the “constant volume” condition, for which the air contribution to the temperature dependence vanishes. However, it is challenging to guarantee leak tight performance for 25 years. Therefore, an alternate approach to improving stability is to place a second glass element in the second beam path. The differential optical path length between the two arms must be kept absolutely accurate and constant to a high level of precision (1 part in 10⁴) to maintain a constant period of 100.00 or 200.00 GHz, for example. The approximate optical frequency is 193.000 THz, and its phase should be aligned to the ITU wavelength grid to better than 1 GHz (1 part in 10⁶) The relative frequency deviation must then be maintained below 10⁻⁶. Practically, there is no glass material available whose temperature dependence is matched to the temperature dependence of air to this level of precision. Therefore, this second glass material is desirable to compensate for the temperature dependence introduced by the first glass.

It is also advantageous to place glass elements of equal or almost equal length in both arms to eliminate the dependence of the interleaver's frequency response on ambient air conditions, which can be significant for 50 GHz and more closely channel spaced interleavers. 50 and 100 GHz interleavers include glass elements of total differential lengths D/ and 2D/ in this example, where physical lengths L are typically 8 to 16 mm for suitable glass types. The tolerances of L are less than 1 um, requiring precise thickness or optical path length control during the polishing process. Optical glasses are supplied in large quantities with optical consistency superior to that of crystals, providing easier manufacturability and lower cost. Therefore, each interleaver stage does not require an individually polished delay line pair that varies in accordance with the optical material batch. As shown in the example of FIG. 1, delay elements of a stage are of total differential lengths which are integer multiples, so all glass elements of one type can be of uniform length, and merely disposed in a series of a selected number. Although the examples are based on a length L for a 100 GHz stage, with multiple lengths for successively closer channel spacings, such as 50 GHz, 25 GHz, etc. It will be appreciated that wider spacings (200 GHz, 400 GHz, etc.) will use fractional lengths of L, so that an integral divisor might also apply. This two glass approach achieves thermal drift characteristics of 0.01 GHz/° C. to 0.04 GHz/° C.

The two glass design requires that the temperature characteristics of the glasses be precisely matched if passive athermal response is desired. The transmission frequency response of a single interleaver stage is given by:

T=sin²(φ) (8)

where the phase is given by:

$$φ = \frac{2 π f}{c} ( ( {n}_{1} - {n}_{air} ) {L}_{1} - ( {n}_{2} - {n}_{air} ) {L}_{2} ) \qquad ( 9 )$$

The frequency dependence of the phase is:

$$\frac{\partial φ}{\partial f} = \frac{2 π}{c} ( ( {n}_{1} - {n}_{air} ) {L}_{1} - {n}_{air} ) {L}_{2} ) + \frac{2 π f}{c} ( \frac{\partial {n}_{1}}{\partial f} {L}_{1} - \frac{\partial {n}_{2}}{\partial f} {L}_{2} ) \qquad ( 10 )$$

and the temperature dependence of the phase is:

$$\frac{\partial φ}{\partial T} = \frac{2 π}{c} ( ( {n}_{1} - {n}_{air} ) \frac{\partial {L}_{1}}{\partial T} - ( {n}_{2} - {n}_{air} ) \frac{\partial {L}_{2}}{\partial T} ) + \frac{2 π f}{c} ( \frac{\partial {n}_{1}}{\partial T} {L}_{1} - \frac{\partial {n}_{2}}{\partial T} {L}_{2} ) \qquad ( 11 )$$

The frequency periodicity of the total interleaver is then:

$$Δ f = \frac{c}{( ( {n}_{1} - {n}_{air} ) {L}_{1} - ( {n}_{2} - {n}_{air} ) {L}_{2} ) + f ( \frac{\partial {n}_{1}}{\partial f} {L}_{1} - \frac{\partial {n}_{2}}{\partial f} {L}_{2} )} \qquad ( 12 )$$

For example, for a 50 GHz interleaver, Df=100 GHz, and for a 100 GHz interleaver, Df=200 GHz. The frequency periodicity of individual glasses 1 and 2 under the condition of temperature compensation is:

$$\begin{matrix}Δ {f}_{1} = Δ f ( 1 - \frac{\frac{\partial {f}_{1}}{\partial T}}{\frac{\partial {f}_{2}}{\partial T}} ) & ( 13 ) \\ Δ {f}_{2} = Δ f ( \frac{\frac{\partial {f}_{2}}{\partial T}}{\frac{\partial {f}_{1}}{\partial T}} - 1 ) & ( 14 )\end{matrix}$$

By choosing L₁=L₂, the temperature dependence of air factors out of the interleaver frequency response. If this condition were not met, a 6 mm element of air would contribute afrequency shift of approximately 3 GHz/10° C. In practice, the lengths of the two glass elements are matched to within a few hundred microns to minimize the temperature dependence of the interleaver. This effect also depends on whether the interleaver operates under constant pressure or constant volume conditions. Under typical telecom grade packaging conditions, the package is leak-tight. However, over a 25 year operating lifetime, it is challenging if not impossible to maintain either constant pressure or volume conditions, even for a leak-tight package. This makes the interleaver very difficult to passively temperature compensate over the entire lifetime of the component if the interleaver frequency response has a significant contribution from an air element. As a result, we have designed the interleaver with nearly equal lengths of glass and air in each arm, so that the temperature dependence of air factors out of the interleaver response. This does require, however, excellent temperature uniformity across the optical package to ensure that thermal gradients within the individual filter stages are sufficiently low. Tuning of Periodicity

While general considerations and specific examples of tuning of periodicity have been given above, some other factors should also be borne in mind. The frequency period of interleaving filters are to be configured to the precise ITU standard wavelength spacings of 25, 50, or 100 GHz, for example. The tolerance on the frequency period of the 50 GHz interleaver, for example, is about 5 MHz. The frequency period of the interleaver depends primarily on the optical path lengths of the pair of delay line elements. If the lengths of the optical delay line elements (glass windows, for example) are controlled to the 0.1 um level, then no period tuning may be required. However, it is advantageous from a yield point of view to have some range of adjustability when placing the parts. To achieve this in a practical manner, first the optical delay line lengths should be controlled to the sub 0.5 um level. The remaining inaccuracies in lengths can be tuned out during assembly by tilting the polarization beam splitters relative to the optical beam. For an interleaver stage exhibiting 100 GHz periodicity, the amount of frequency tuning per arcsecond of tilt is 0.1 MHz/arcsec. For an interleaver stage exhibiting 50 GHz periodicity, the amount of frequency period tuning per arcsecond of tilt is 0.0283 MHz/arcsec. Since the upper and lower beams have nearly the same optical delay line lengths, the periods of both beams are tuned simultaneously. This tilt can be applied about a vertical or horizontal axis. The typical amount of angular tilt required is about +/−3 arcmin to achieve the full range of tuning required.

The lengths of the input and output pbds of each stage also require precise matching of physical length to ensure that the two delay paths travel the same distance through the beam displacer. This ensures that the beam displacers do not cause the frequency period to be out of range of frequency period tuning. In addition, the length matching eliminates any temperature dependence arising from the pbds and ensures that the two beams are combined into a single overlapping beam at the output. This is necessary to achieve a low loss, low crosstalk interleaver.

Tuning of Phase

The periodic interleaver response must be precisely aligned to the optical frequency channels of the ITU grid. A tilt approach to frequency period tuning can change the phase; however, the sensitivity of absolute phase to tilt is exceedingly high. Therefore, after period tuning, it is desirable to have a technique to make the final adjustments to phase after interleaver time delay elements may have been bonded in place, properly cured and stabilized. Typically, the upper and lower beams must be independently phase tuned because of slight variations in the optical path length differences of the upper and lower beams. These variations arise from parallelism or transmitted wavefront errors in the microoptic elements. A post-assembly phase tuning technique has therefore been developed to align the periodic wavelength response to the absolute wavelengths defined by the ITU standard, for example. The phase tuning unit that has been described generally in FIGS. 4 and 5 consists of a ¾ waveplate 42 oriented at 45 degrees, a pair of ½ waveplates, 43, 44, one each for the upper and lower pair of beams, and a second ¾ waveplate 45 oriented at −45 degrees (FIGS. 4 and 5). The set of 4 waveplates associated with an individual time delay stage can be placed before the input pbs, after the output pbs, or anywhere in relation to the glass but between the input and output pbs. Advantages are derived by placing the 4 elements outside the pbs's where there are 2 rather than 4 beams, because the opportunity to clip beams is minimized.

The states of polarization within the phase tuning subassembly are illustrated in FIG. 5. Pure phase tuning is achieved by rotating a ½ waveplate 43 or 44 by an angle providing the needed phase shift in the frequency response. The upper and lower pairs of beams may thus be independently phase tuned to eliminate upper and lower phase differences arising from potentially poor parallelism (i.e., >1 arcsec) and transmitted wavefront (>I/100) characteristics of the microoptic elements within each stage. A one degree rotation of the ½ waveplate corresponds to a 4 degree phase shift. This phase shift is equivalent to 1.11 GHz for a 100 GHz periodic response. In general, the phases are set to better than 0.5 GHz from the nearest ITU channel frequency by using this technique. This approach to phase tuning has no effect on the absolute period of the stage. The separation of the period and phase tuning steps in the assembly process significantly increases the manufacturing yield and the precision in which the frequency of the interleaver can be set.

Channel Isolation and Crosstalk

For high data rate telecom applications low adjacent channel crosstalk over a wide stopband is required. To achieve a 30 GHz stopband at the −18 dB crosstalk level, only a particular range of angles is allowable. An arbitrary filter shape can be generated by adding additional passband shaping stages consisting of synthetic birefringence elements separated by waveplates. However, the number of stages is practically limited by insertion loss, cost and package size considerations. A single stage exhibits a sinusoidal transmission characteristic and exhibits contrast in excess of 20 dB. The stopband for a single stage is exceedingly narrow, however. High crosstalk performance, namely, wider passbands and stopbands, is achieved by using a three stage design for a 50 GHz interleaver. The resulting optical frequency spectrum for two adjacent channels is illustrated in FIG. 8. One design has maximized the width of the stopband at the −18 dB level, while maintaining the crosstalk at the center of the passband below the −22 dB level. For this design the required angle between the first stage of differential length D/ and the second stage of differential length 2D/ is −33 (+/−1) degrees. The required angle between the second stage and the third stage of length 2 D/ is 13.9 (+/−1) degrees. The physical length L of a delay line for typical glasses is 4 to 10 mm. Table 1 lists the orientations of the four interstage waveplates which achieve the low crosstalk and high passband flatness optical performance. Note that a range of angles, generally about +/−1 degree, also give adequate optical performance. To achieve these accuracies during assembly, an in-line polarimeter is used during the assembly to correctly orient these waveplates.

TABLE 1

| Interstage | State of | Waveplate |
|---|---|---|
| Waveplate | polarization | angle |
| #1 | 45.0 | 22.5 |
| #2 | 66.0 | 33.0 |
| #3 | 27.8 | 13.9 |
| #4 | 6.8 | 3.4 |

The key optical performance characteristics of this three stage design are low crosstalk <−22 dB, wide passbands >10 GHz, wide stopbands >10 Ghz, and athermal operation.

Interleaving filters can thus be designed with one or more filtering stages of this type oriented at different relative angles to tailor the filtering characteristics. The three stage design readily achieves the level of crosstalk and flatness performance required for demultiplexing in high data rate systems. A two stage design reduces the number of microoptic elements needed, but sacrifices optical performance such as passband flatness and stopband width. A single stage, however, can also be useful for some applications where a less demanding transfer function is involved. Fewer elements do translate into lower optical loss in transmission.

Low PMD Operation

Several design considerations must be satisfied to achieve low PMD operation in interleavers, such as the interleaver of FIGS. 1-3. In the approach shown, a ½ waveplate 22 oriented at 45° is placed between the two polarizing beam splitters 18, 35 to match the optical path length for the two orthogonal polarizations. As is apparent from the Figures, the two optical beams travel exactly the same distance through the pair of beam splitters even though two beams travel different distances through any individual beam splitter. This same 90 degree polarization rotation is achieved within the phase tuning subassembly, by using the ½ waveplate between ¼ or ¾ waveplate pairs with a relative angle of 90 degrees between the ¼ or ¾ waveplates to provide a fixed state of polarization exiting the phase tuning subassembly, so that the angle of an interleaving ½ waveplate simply shifts the phase of the frequency response of the individual stage. It will be recognized that the ¾ waveplate is a higher order ¼ waveplate.

Furthermore, the PMD of the interleaver is reduced to the sub 0.1 ps level by inserting 45° and −45° polarization rotators in the assembly of FIG. 1 immediately after the input beam splitter. These polarization rotators may be ½ waveplates or Faraday rotators, for example. This ensures that identically polarized beams are launched into the cascaded filtering stages. Since the polarizations of the two beams at the input to the filtering stages are identical, the corresponding complex amplitudes of the two beams at the output of the three filter stages are equal and the response of the first interleaver output becomes Εᵢₙa . The group delay for this output is illustrated in FIG. 16. It is important to note that the group delay is independent of input polarization into the interleaver, because the two orthogonal input polarizations are converted to a single polarization (o, for example) which enters the subsequent filtering stages of the interleaver. As a result of these design considerations, the differential group delay is not polarization dependent, so that the PMD is zero.

Alternative Variants

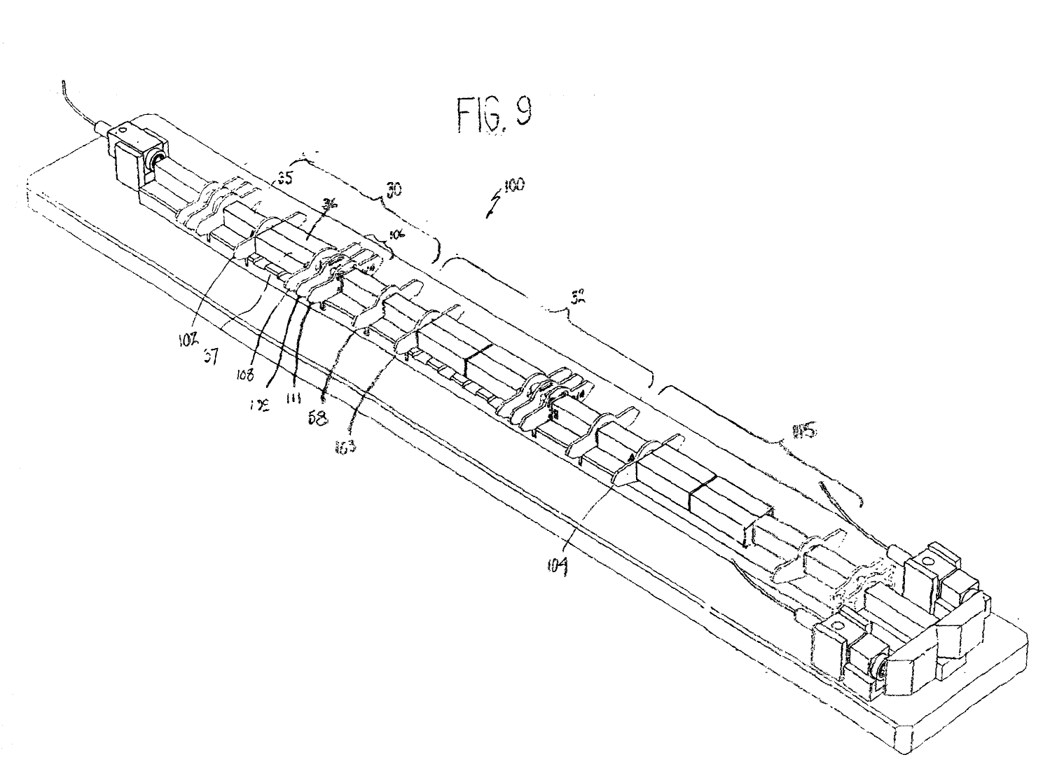

The 50 GHz interleaver 100 of FIG. 9 corresponds in large part to the example of FIGS. 1-3 incorporates certain modifications having particular utility for certain designs. Components and combined units with geometries and functionalities corresponding to the example of FIGS. 1-6 are either correspondingly numbered or not numbered, since primarily only the differences will be described.

In FIG. 1, each stage 30, 32, 34 includes a ¼ waveplate 102, 103 or 104 immediately prior to the optical delay lines of a stage, such as the glass elements 36, 37 of the first stage 30. Thus linearly polarized beams, spaced apart in four quadrants after the beam splitting splitter 35, are converted to circularly polarized beam pairs in which the beams of the upper pair and lower pair are each in opposite sense of rotation at −45° and +45° respectively. The beams traverse the lengths of the delay lines 36, 37 and then the three element waveplate arrays 106, in which the first two are ½ waveplates 108, 109 for frequency and phase tuning, as in FIGS. 1-6. However, the third waveplate 111 is a ¼ waveplate for transferring the beams back to linear polarization for succeeding polarization sensitive devices. This variant preserves the needed beam orthogonality during retardation but also helps to reduce internal reflections which cause ripple in transmission. Reflection losses may also be reduced by tilting the glass elements, or angling their end faces, by a small angle (e.g. about 1°).

Another variant from the arrangement of FIGS. 1-6 is introduced after the delay lines in the third stage 34. Here, only a ¼ waveplate 113 is employed to return to linear polarization. The ½ waveplates for frequency and phase tuning are omitted since it is found for some applications that two earlier tuning stages can provide adequate conformity to an ITU grid. The use of linear or circular polarization in this manner in the microoptic elements reduces backreflection and transmission ripple in the assembly.

### Low Crosstalk, Two Stage 25 GHz Interleaver

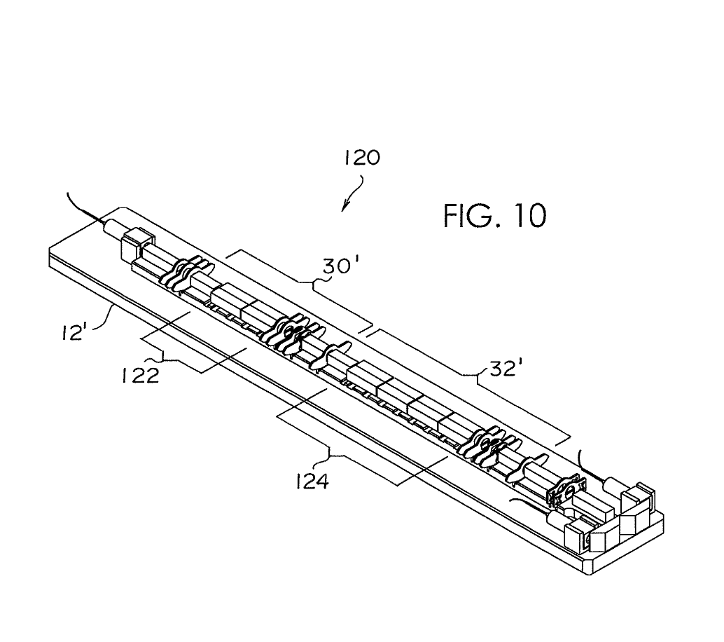

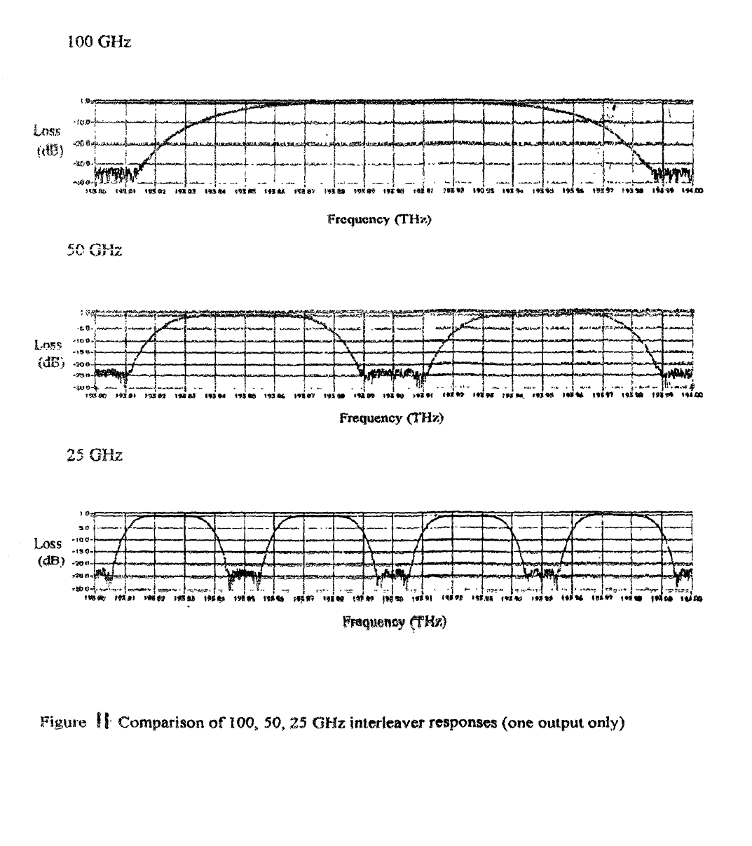

As DWDM systems evolve to ever increasing channel densities, the filtering requirements at tighter channel spacings demand the use of longer delay line elements within the interleaver. Glass elements of substantially different refractive indices are advantageous in obtaining smaller form factors than other approaches. Nevertheless, to go from a 50 GHz interleaver to a 25 GHz interleaver requires that the glass elements be increased in length by a factor of two to scale the frequency periodicity by a factor of 0.5. One design approach to maintain a compact size is to utilize a two rather than three stage interleaver. A detailed drawing of the mechanical and optical design of such an interleaver for 25 GHz spacing is illustrated in FIG. 10.

In this interleaver 120, the polarization beam splitters, frequency and phase tuning arrays, function shaping waveplates and output power decoder elements are essentially as shown and described relative to FIGS. 1-3, and the description need not be repeated. The delay line sections 122 in the first stage 30′ and 124 and in the second stage 32′ are of differential lengths that are integer multiples of D/, namely 2D/ in the first delay lines 122 and 4D/ in the second delay lines 124. Using this modular approach based on a nominal delay line differential length DI, and athermal pairing of adjacent delay elements, only the optical bench 12′ needs to be different.

Table 2 below shows the interstage waveplate angles which achieve the desired response. This design gives an adjacent channel crosstalk of 22 dB, although a two stage interleaver in general displays narrower stopbands than a three stage design. 25GHz interleavers introduce new challenges to interleaver design beyond that of the 50 GHz interleaver. Because of the denser channel spacing, athermal temperature compensation is even more critical to provide adequate performance over the entire operating temperature window. The two glass design excels in this respect. In addition, the longer path length delays necessitate the use of longer delay assemblies. The glass designs described herein naturally achieve compact delay line assemblies. This enables low insertion loss to be maintained in interleavers for denser channel spacings. Insertion loss is typically a function of the working distance of fiberoptic collimators. Loss and collimated beam spot size increase with the working distance of collimators. Therefore, a minimization of working distance reduces the insertion loss and enables smaller microoptic components to be utilized because of the corresponding reduction in spot size. These same advantages allow this approach to be extended to three stage 25 GHz designs and to sub-25 GHz designs.

TABLE 2

| Interstage | State of | Waveplate |
|---|---|---|
| Waveplate | polarization | angle |
| #1 | 45.0 | 22.5 |
| #2 | 56.0 | 28.0 |
| #3 | 15.6 | 7.8 |

### Low Crosstalk, Three Stage 25 GHz Interleaver

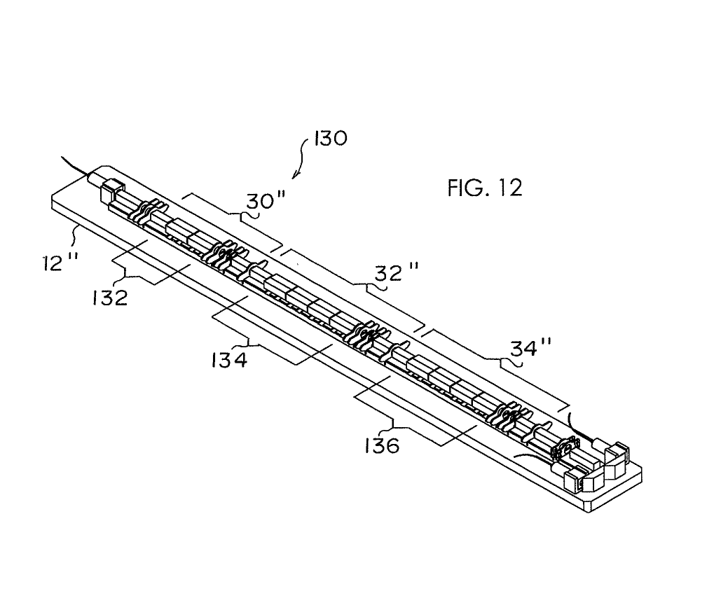

The compact nature of the athermal, glass delay line approach enables higher performance interleavers to be fabricated by a modular approach. For example, an alternate design of a 25 GHz interleaver 130 (FIG. 12) utilizes three stages (30″, 32″, 34″), which can be configured to reduce the adjacent channel crosstalk to 30 dB over a wider stopband than the two stage design. The interstage waveplate angles are summarized in Table 3 and a detailed representation of the mechanical and optical design is illustrated in FIG. 12. This illustrates that three successive delay stages 30″, 32″ and 34″ are comparable to the prior examples, with a first 2D/ (50 GHz) delay section 132, and second and third 4D/ (25 GHz) delay sections 134, 136 respectively.

TABLE 3

| Interstage | State of | Waveplate |
|---|---|---|
| Waveplate | polarization | angle |
| #1 | 45.0 | 22.5 |
| #2 | 66.0 | 33.0 |
| #3 | 27.8 | 13.9 |
| #4 | 6.8 | 3.4 |

### Low Crosstalk Two Stage 12.5 GHz Interleaver

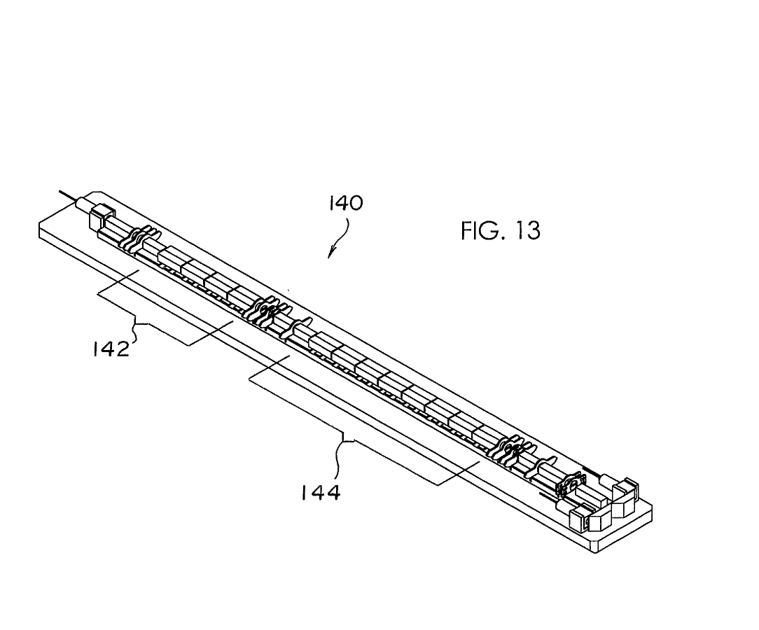

The 25 GHz two stage design of FIG. 10 can also be applied to a 12.5 GHz interleaver by simply increasing the lengths of glass by a factor of two. The same waveplate angles are utilized, as summarized in Table 4 below, and a detailed representation of the mechanical and optical design is illustrated in FIG. 13. In this practical example of a 12.5 GHz interleaver 140, the first delay section 142 is modularly constructed of four serial elements of length L per path and the second delay section 144 of eight elements per path. With these dense channel spacings particular care is required to maintain dimensions and function shaping angles within close tolerances. The period tuning and phase tuning capabilities disclosed in this patent become of paramount importance in realizing manufacturable interleavers of this type.

TABLE 4

| Interstage | State of | Waveplate |
|---|---|---|
| Waveplate | polarization | angle |
| #1 | 45.0 | 22.5 |
| #2 | 56.0 | 28.0 |
| #3 | 15.6 | 7.8 |

### Low Crosstalk Three Stage 100 GHz Interleaver

As DWDM systems move to increasing channel densities beyond 200 GHz, demultiplexing technologies such as thin film filters begin to experience performance limitations. An approach to utilize 200 GHz thin film filters at higher channel counts incorporates 100 GHz interleavers to separate channels onto two separate 200 GHz paths. To achieve crosstalk below −30 dB over a 20 GHz wide stopband, a three stage design incorporating interstage waveplates at the angles indicated in Table 5 is feasible.

TABLE 5

| Interstage | State of | Waveplate |
|---|---|---|
| Waveplate | polarization | angle |
| #1 | 45.0 | 22.5 |
| #2 | 66.0 | 33.0 |
| #3 | 27.8 | 13.9 |
| #4 | 6.8 | 3.4 |

### Zero Chromatic Dispersion Interleaver Pair

As described above, the corresponding complex amplitudes of the two beams at the output of a final filter stage are equal and given by Εₗₙa at the first interleaver output. Accordingly, if the e polarized principal polarization state is rotated in the opposite sense (i.e., −450) and the o polarization is rotated 45°, the two orthogonal input polarizations are converted into a single polarization (e in this case). Because of this polarization rotation before the filtering stages, the response of the first interleaver output then becomes Eₗₙa* and thus the group delay response of the filter at the first interleaver output is inverted from that of the previous example. The group delay responses for these two outputs for a representative example (i.e. 50 GHz interleaver) are indicated in FIG. 16. This can be used in order to obtain a matched multiplexer/demultiplexer pair in which the group delay responses have the same absolute value for every wavelength but their signs are inverted. That is, the minimum group delay (in absolute value) for the two outputs occurs at the channel center, and increases in absolute value while detuning within the channel passband. When such a pair is used for multiplexing followed by demultiplexing, the net contribution of these filters to the total chromatic dispersion of the link is zero. The CDs of the complementary outputs are illustrated in FIG. 17. It is clear that the CD of the sum is identically equal to zero over the transmission window of the filter. Therefore, the even channels will have CD of opposite sign to the odd channels for an individual interleaver. By suitably configuring the input waveplates, the chromatic dispersion of the outputs can be inverted. Alternately, the sense of the chromatic dispersion of the outputs can be programmed in during phase tuning by establishing the appropriate relative phase relationships between the individual stages (i.e., 0 or 180 degrees). This approach is preferable because the interleaver configuration can be programmed in after the assembly process is complete.

This unique ability to achieve control of chromatic dispersion enables a matched mux/demux interleaver pair to be produced which produces zero net chromatic dispersion, as shown generally in FIG. 14. Alternately, for some applications multiplexing is performed with a 50/50 splitter rather than an interleaver. In this case, zero CD can be achieved if multiple demultiplexers are used in a single link, as in add/drop applications, for example, by suitable pairing. This is effected by configuring demultiplexers as pairs with dispersion of compensating signs. Note that an interleaver does not need to be configured as a multiplexer to compensate for the CD of a demultiplexer; in fact, the bi-directional nature of these interleavers enables any one component to function as both a multiplexer or demultiplexer.

The tunable, chromatic dispersion compensator is based on cascading two suitably configured interleavers in series. The group delay of an interleaver can be either quadratic up or quadratic down, depending on whether the ordinary or extraordinary polarization is used as the input to the filtering stages, or depending on the relative phases between the individual time delay stages. The approximately quadratic group delay produces an approximately linear dispersion characteristic within the channel passband. Two cascaded interleavers may thus be arranged to cancel out the dispersion slope and provide a constant dispersion, as shown schematically in FIG. 14. The amount of dispersion can be tuned by introducing a wavelength shift of the first interleaver relative to the second interleaver. The shift can be produced by tuning the absolute frequency of the interleaver. The passband must be sufficiently low loss within the desired tuning range. For example, a pair of modified 50 GHz interleavers will enable a fixed amount of dispersion to be produced at all channels on a 100 GHz grid passing through the interleaver. This implementation has the advantage that only a single tunable chromatic dispersion compensator is required for a multitude of WDM channels. This approach also has the advantage of simultaneously reducing interchannel crosstalk.

### Zero Chromatic Dispersion Multiplexer and Demultiplexer Pairs

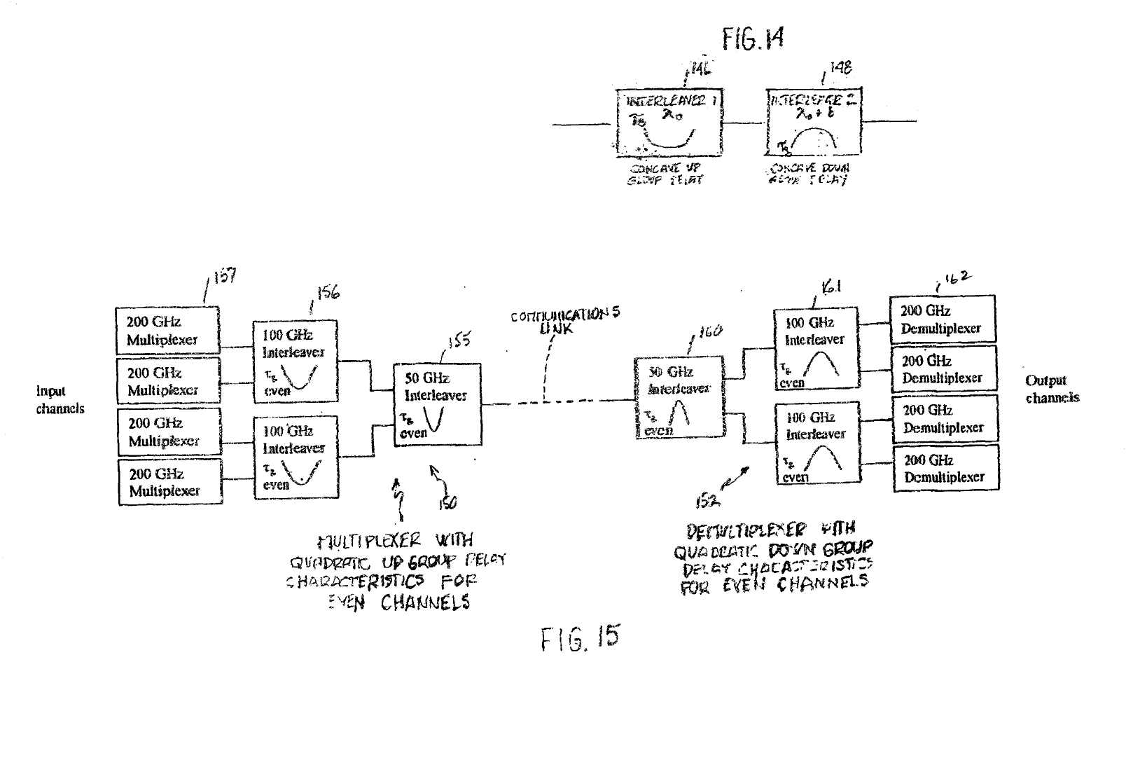

The chromatic dispersion of an interleaver is different in slope for the even and odd channel interleaver outputs, as described previously. Chromatic dispersion is related to the derivative of the group delay with wavelength. Even channels on the first output have quadratic up group delay characteristics, and odd channels on the second output have quadratic down group delay characteristics. By properly orienting waveplates within the interleaver, the sign of the dispersion for the even and odd channels can be alternated. In most applications, interleavers are used as both multiplexers and demultiplexers. In this case, as seen in FIG. 15, multiplexers 150 can be fabricated to provide quadratic up group delay for even channels (down for odd channels), and demultiplexers 152 can be fabricated to provide quadratic down group delay for even channels (up for odd channels). Alternately, demultiplexers can be configured to provide either up or down group delay for even channels. However, the odd channels will have group delays of opposite sign.

FIG. 15 shows a multiplexer 150 with a converging hierarchy of levels 155, 156, 157 from 200 GHz to 100 GHz and then 50 GHz, the two more closely spaced channel levels having quadratic up group delay characteristics for even channels. The demultiplexer 152, has by contrast a three level hierarchy of diverging multiplexers 160, 161,162 of quadratic down group characteristics for even channels in multiplexers of 50 GHz and 100 GHz channel spacing.

This ability to tailor the group delay characteristics is a significant advantage of these athermal delay line based interleaver designs. The combined mux/demux pair exhibits truly zero dispersion for all channels. This technique provides significant performance enhancements over other interleaver technologies, which do not enable the sign of the chromatic dispersion to be controlled. Interleavers based on Gires-Tournois interferometers (GTI), for example, only exhibit quadratic up group delay characteristics. The dispersion for a GTI based mux and demux pair is then equal to twice that of the individual components, which for this channel spacing is excessive. Furthermore, fiber grating based interleavers are difficult to fabricate with tightly controlled chromatic dispersion because they suffer from group delay ripple. Therefore, the synthetic birefringent interleaver components disclosed herein have the significant advantage that they are truly zero dispersion for all channels if they are suitably configured as pairs. Zero chromatic dispersion is an essential performance parameter for state-of-the-art 40 Gbits/s transmission systems.

### Synthetic Birefringence Using an Air-Based Delay Line

An optical path length difference can also be provided by varying the paths of the beams of two polarizations in air. A single interleaver filtering stage 165 based on this general concept is illustrated in FIG. 20. An air delay line element 167 within the stage 165 introduces differential retardation within a stage by extending one beam path using reflections to provide bidirectional beam segments of a selected total length. Prior to retardation, an input beam is split into two displaced and orthogonally polarized beams by a polarization beam splitter 169. After retarding one beam relative to the other, the beam pairs pass through a ½ waveplate 171 at 45° before recombination of the beams by a second polarizing beam splitter 173 into a single beam. This simplified example assumes a preselected angle of input polarization.

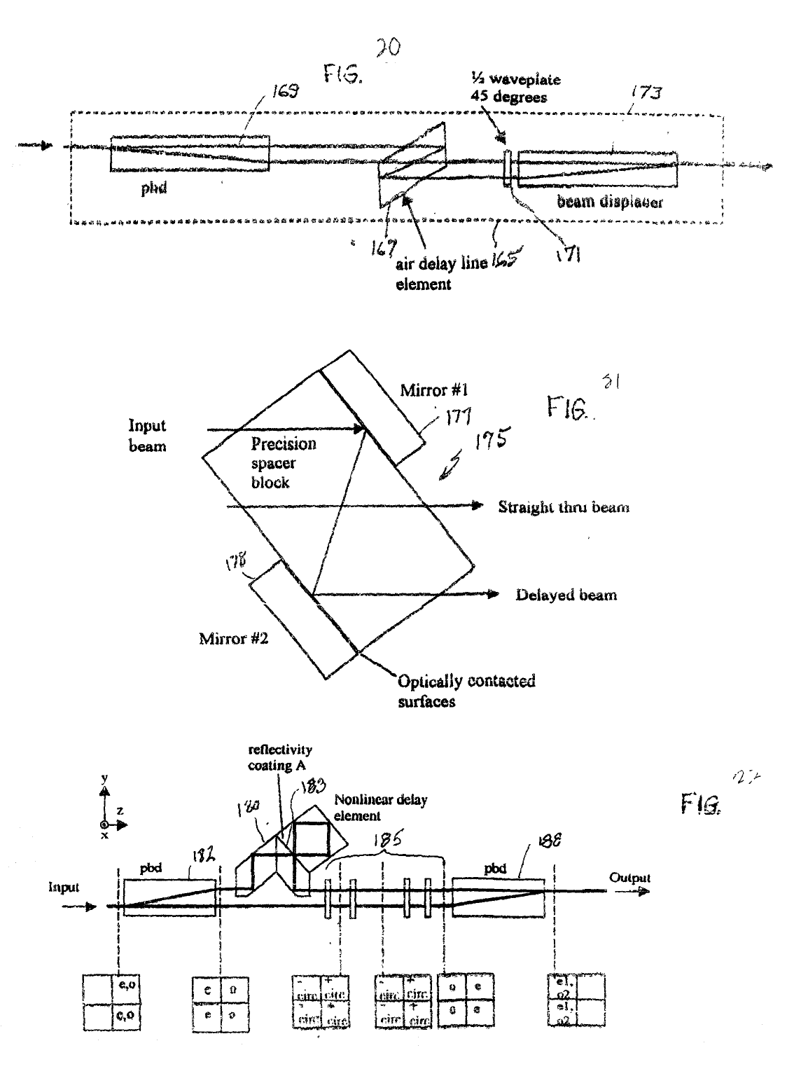

Referring now to FIG. 21, an air spaced delay line fabricated 175 from Corning ULE glass, for example, can achieve the desired differential retardation periodicity. Because the optical beams travel through air, chromatic dispersion of transmissive optics is not a factor. The ULE glass has a small thermal expansion coefficient (1 0⁻⁸) so that the optical performance of the device less sensitive to temperature. However, the dependence of optical path length on the air or atmospheric conditions is still a factor that must be minimized. Mirrors 177, 178 at the ends of the spacer 175 are high reflectivity coated with a dielectric stack and attached to the spacer using optical contact, in which atomic bonding of two flat, clean surfaces forms a permanent bond. This ensures extremely stable operation of the element across a wide temperature range. Since the beams in each arm travel different distances, the temperature dependence of this stage is equivalent to an element of air whose length is equal to the optical path length difference of the stage. To compensate this temperature effect, a suitable mirror spacer material must be selected. Glass materials from vendors such as Ohara, Schott and Corning with well characterized thermal expansion coefficients are suitable for this spacer material. Alternately, the optical length of the delay line can be mechanically, electrically or thermally adjusted to provide a reconfigurable filter. This flexibility is attractive for CD and PMD compensation applications.

Nonlinear Time Delay Element

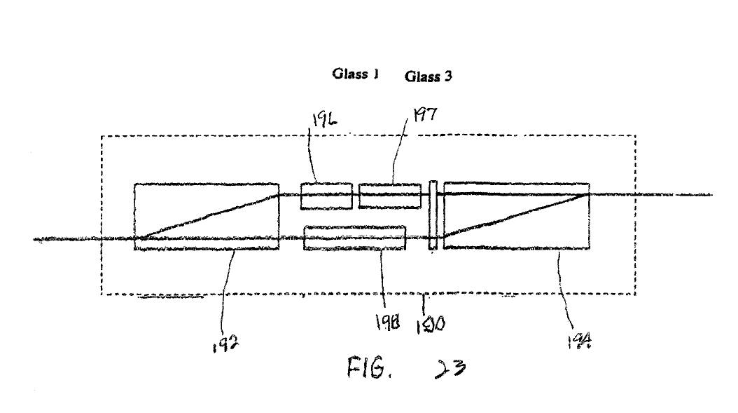

One approach already described to achieving flat passbands and low crosstalk in a polarization interferometer is to cascade multiple time delay stages. An alternate approach to achieve comparable total delay is to utilize a single delay line element with a nonlinear loop mirror 180 in one arm, as shown in FIG. 22. The round trip length of one beam pair from a polarization beam splitter 182 through the closed loop mirror 180 is precisely adjusted to give the desired periodic response in frequency. The light path is directed in a low loss manner within the delay element through total internal reflection. The reflectivity of an internal surface A (183) is adjusted to give the desired interleaver transmission characteristics, and a further phase tuning may be done in a waveplate array 185. As the reflectivity of surface A is increased from about 5% to 70%, the shape of the transmission response increasingly resembles a square wave with a duty cycle of 50%. However, the crosstalk within the stopband and the chromatic dispersion within the stopband also increase at higher reflectivities. A reflectivity which is a suitable compromise between stopband width and crosstalk level is approximately 30%. A nonlinear loop mirror can also be placed in the other arm of the delay line element to modify the response further. A final polarization beam splitter 188 derives the intensity modulated, interleaved output beam pair.

The advantage of this approach is that a single nonlinear time delay stage can produce substantially the same transmission response as the cascaded, finite impulse response (FIR) multi-stage interleaver designs described earlier. One drawback from an optical performance perspective is the increased dispersion originating from the well known infinite impulse response (IIR) characteristics of the loop mirror. A matched pair demultiplexer or multiplexer to cancel chromatic dispersion does not exist for this type of filter. For device applications that require high chromatic dispersion (e.g., tunable dispersion compensators), this ability to produce large chromatic dispersion may be an advantage. FIR filters can be designed to provide zero chromatic dispersion, while practical IIR filters can not be configured to provide zero chromatic dispersion.

Method of Assembly

The optical transmission characteristics of the interleaver are primarily determined by the relative azimuth angles between the two or more time delay stages. The time delay stages can be physically oriented at suitable relative angles by suitable mounting. It is preferable, however, for all time delay stages to be mounted on a single reference plane, wherein the relative angles are instead determined by interstage waveplates. Then to ensure consistent optical performance in a manufacturing environment, the state of polarization is measured as each microoptic part is inserted. The state of polarization is measured by using a broadband light source in the wavelength region of interest (1530 to 1565 nm, for example) and a polarimeter. Suitable polarimeters are available from Agilent, ThorLabs and Instrument Systems. The waveplates are then oriented to generate the design angles. Examples of these design angles are described in Tables 1-5. These angles are measured relative to the polarization reference frames established by the polarization beam splitters (pbds). In some cases, limitations in the accuracy of the orientation of the crystallographic axes of the pbds demand that the pbd optical axis angles be measured and any errors be corrected for. As waveplates are installed, the desired orientations of the states of polarization are then determined in reference to the measured optical axes of the individual pbds.

Three Glass Athermal Delay Lines

The differential retardation of beams can be produced by a differential optical path length for the two orthogonally polarized beams by placing material(s) of different indices of refraction and/or lengths in the two orthogonally polarized beam paths. Referring now to FIG. 23, in a single stage 190 shown by way of example, linearly polarized light is split by a polarization beam splitter 192 into two orthogonal polarization components, then is propagated in two adjacent paths through non-birefringent optical elements and recombined using a second beam splitter 194 identical in length to the first. The delay difference between the two paths is created by introducing glass into the optical paths to provide an optical path length imbalance. In particular, one or more glass pieces 196, 197 can be placed in one beam (of physical lengths L₁, L₃) and one glass piece 198 can be placed in the other beam (of physical length L₂), as shown in FIG. 21. However, the requirements that concurrently exist as to the phase difference, channel spacing and athermal response must also be met. By introducing a third glass, greater flexibility is obtained in the selection of suitable glasses and potentially improved passive temperature compensation may be achieved over that of the single or two glass designs. The basic mathematical relationships to be met for the three glass design are described below. The optical path length difference between the two beams is:

Δl=(n₁−nₐᵢᵣ)L₁−(n₂−nₐᵢᵣ)L₂+(n₃−nₐᵢᵣ)L₃, (15)

where n_{1,2,3} are the refractive indices of the glasses and L_{1,2,3} are their physical lengths. Their phase difference is:

$$φ = 2 π \cdot \frac{Δ s}{λ} = \frac{2 π f}{c} [ ( {n}_{1} - {n}_{air} ) {L}_{1} - ( {n}_{2} - {n}_{air} ) {L}_{2} + ( {n}_{3} - {n}_{air} ) {L}_{3} ] , \qquad ( 16 )$$

where

λ, f and c are the wavelength, frequency and speed of light, respectively.

Channel Spacing Condition:

$$Δ f = \frac{2 π}{\frac{ⅆ φ}{ⅆ f}} = \frac{c}{[ {L}_{1} ( {n}_{1} - {n}_{air} - λ \frac{ⅆ {n}_{1}}{ⅆ λ} ) - {L}_{2} ( {n}_{2} - {n}_{air} - λ \frac{ⅆ {n}_{2}}{ⅆ λ} ) + {L}_{3} ( {n}_{3} - {n}_{air} - λ \frac{ⅆ {n}_{3}}{ⅆ λ} ) ]} \qquad ( 17 )$$

It has been determined that in the frequency window in which the interleaver operates (e.g., 1500 to 1600 nm),

$$\frac{ⅆ φ}{ⅆ f}$$

is nearly independent of frequency f for most materials.

Therefore, channel walk-off is insignificant if the glass lengths are determined according to Eq. (17)

There are two temperature effects which need to be considered to achieve athermal operation. The first consideration is the temperature dependence of all the glass pieces, which introduces an absolute frequency shift of the interleaver response. To cancel the glass temperature effects, one has to satisfy the following equation:

$$\frac{ⅆ φ}{ⅆ T} = \frac{2 π f}{c} [ \frac{ⅆ {n}_{1}}{ⅆ T} \cdot {L}_{1} + ( {n}_{1} - {n}_{air} ) \cdot {L}_{1} \cdot {α}_{1} - \frac{ⅆ {n}_{2}}{ⅆ T} \cdot {L}_{2} - ( {n}_{2} - {n}_{air} ) \cdot {L}_{2} \cdot {α}_{2} + \frac{ⅆ {n}_{3}}{ⅆ T} \cdot {L}_{3} + ( {n}_{3} - {n}_{air} ) \cdot {L}_{3} \cdot {α}_{3} ] = 0 \qquad ( 18 )$$

where α_{1,2,3} are the thermal expansion coefficients of the glasses. An additional contribution to the temperature dependence arises from a potentially unbalanced air path. The index of refraction change with temperature for the air path is enough to create a change in optical path length. To eliminate this air path temperature contribution, one can make the air path length of both arms equal by having:

L₁+L₃=L₂ (19)

In general, any three different types of glass can yield a set of L₁, L₂ and L₃ that satisfy Equations (17), (18 and (19). For example, if glasses 1, 2 and 3 are chosen to be Schott glass types SF-L57, N-ZK7 and LaS F-N31, the corresponding glass lengths are L₁ =2.143 mm, L₂ =8.544 and L₃ =6.401 mm, respectively. The selection of glasses is primarily guided by glass availability, cost, ease of optical fabrication, and requirements imposed on the physical length of the interleaver.

In summary, interleavers based on athermal optical delay lines have several advantages. They display true zero chromatic dispersion for a mux/demux or suitably configured demux/demux pair. They exhibit an unprecedented level of insensitivity to temperature change. Their flexible, multi-stage design allows crosstalk performance to be tailored to meet customer's needs through a modular approach. These interleavers are designed to be manufacturable in large quantities, and are fabricated primarily from “off the shelf” optical components which are readily available.

Although there have been described, and illustrated in the drawings, various forms and modifications in accordance with the invention, it will be appreciated that the invention is not limited thereto, but encompasses all alternatives and variations within the scope of the appended claims.

What is claimed is:

1. A microoptic element with synthetic birefringence for modifying the transmission characteristics of an input optical beam comprising first and second polarization beam splitter devices, wherein the first polarization beam splitter device separates the input beam into first and second orthogonally polarized output beams along first and second beam paths, a first non-birefringent optical delay line in the first beam path arranged such that the first beam undergoes a first time delay, a second non-birefringent optical delay line in the second beam path arranged such that the second beam undergoes a second time delay, different from the first, with the time delay difference being precisely determined by optical path length difference between the optical delay lines, and the second polarization beam splitter device being arranged to recombine the first and second delayed beams into a single beam having interfering components defining the desired modification in transmission characteristic

2. An element in accordance with claim 1 wherein the delay lines are glass elements interposed in each beam path and the glass elements are selected to provide athermal time delay difference characteristics between the two paths.

3. An element in accordance with claim 2 above, wherein the glass elements have substantially like thermal expansion coefficients selected to maintain the optical path length difference substantially constant over a selected range of temperature variations.

4. An element in accordance with claim 1 wherein the optical delay lines comprise first and second glass elements in the first and second beam paths respectively, the first and second glass elements having approximately the same physical length and different optical indices of refraction providing the chosen time delay.

5. An element in accordance with claim 4 above, wherein the difference in index of refraction is in excess of about 15%.

6. An element in accordance with claim 5 wherein the first glass has an index of refraction of about 1.5 and the second glass has an index of refraction of about 1.9.

7. An element in accordance with claim 1 wherein the lengths of the first and second beam splitters are matched to within 250 microns.

8. An element in accordance with claim 1 wherein the physical lengths of the first and second beam splitters are nominally 6 to 10 mm.

9. An element in accordance with claim 1 wherein the first and second beam splitters are fabricated from YVO4 crystalline material

10. An element in accordance with claim 1, wherein the element comprises a number of serial stages each providing a time delay difference which is an integer multiple of a selected value, and each stage has an athermal response over a selected range of temperatures.

11. An element in accordance with claim 10 wherein the microoptic element includes waveplates disposed in the beam paths at predetermined angles selected to tune the transmission characteristics to a desired optical transfer function.

12. An element in accordance with claim 10 wherein each stage includes a half waveplate oriented at 45 degrees to the vertical axis.

13. An element in accordance with claim 10 further including a phase shifting tuning structure inserted in both the first and second beam paths, said tuning structure comprising:
a first quarter or three quarter waveplate oriented at ±45 degrees;
at least one half waveplate whose orientation is rotatable to align the absolute frequency of output transmission peaks to match a target frequency grid; and
a second quarter or three quarter waveplate.

14. An element in accordance with claim 1 above wherein said difference in optical path lengths is proportional to
$$\frac{c}{Δ f} ,$$
where Δf is the frequency period of the optical transmission response.

15. An element in accordance with claim 1 above, wherein one delay line includes at least two nonbirefringent glass elements in series, wherein the beam paths include air paths between elements, and wherein the difference in air path lengths between the two beams is less than 600 microns.

16. An element in accordance with claim 1 wherein at least one delay line comprises an airspaced delay line providing a precise amount of optical path length difference between the first and second beam paths.

17. An element in accordance with claim 16 above, wherein one of the delay lines comprises at least one glass element and the other of the delay lines comprises at least one air delay line element.

18. An element as set forth in claim 1 above, wherein the element comprises a number of elements in cascading stages and the stages include means for compensating existing chromatic dispersion comprising:
means disposed in the elements in the cascading stages and responsive to polarization of the beams for canceling the dispersion slope and providing substantially constant dispersion.

19. An element as set forth in claim 18 above, wherein the means for compensating chromatic dispersion includes means in association with the stages for controlling the polarization vector angles into the stages.

20. An element as set forth in claim 1 above, including third, fourth and fifth polarization beam splitter elements, the third polarization beam splitter being disposed before the first to split the first input beam into upper and lower orthogonally polarized beam pairs for differential delay, wherein the fourth polarization beam splitter device receives the beam pairs after differential delay, to provide two pairs of wavelength dependent intensity modulated beams of orthogonal polarization and the fifth polarization beam splitter device is disposed after the fourth polarization beam splitter to combine the power of the pairs of orthogonally polarized, intensity modulated beams.

21. An element as set forth in claim 20 above, wherein the element includes wavelength tuning elements in the beam paths associated with the optical delay lines.

22. An element as set forth in claim 21 above, wherein the wavelength tuning elements comprise rotatably adjustable waveplates.

23. An element as set forth in claim 1 above wherein at least one polarization beam splitter is angled relative to the input beam to adjust frequency period.

24. A system for dividing a number of signals periodically spaced in optical frequency propagating on an input waveguide into two sets of signals each having twice the periodic frequency spacing, with the frequencies in the two sets being in alternating relation, comprising:
an input polarization beam splitter coupled to receive the input optical frequencies, the input polarization splitter providing two differently polarized beams as outputs;
a second polarization beam splitter disposed to split each polarized beam into a pair of adjacent beams of orthogonal polarization;
a differential delay stage of two parallel optical delay paths each having at least one non-birefringent optical delay element, the indices of refraction and the lengths of the delay elements in each of the paths being chosen such that the optical signals of different polarizations are differentially retarded in the two pairs of beams by selected amounts relative to the desired periodic spacings;
a polarization combiner receiving the delayed signals from the two paths of the delay stage for combining beams to produce periodic, wavelength dependent states of polarization of selected optical frequency and phase, and
an output polarization combiner responsive to products of the combined beams for recombining beams of different polarizations into two separate intensity modulated outputs, each providing one different frequency set.

25. A system as set forth in claim 24 above, wherein at least one delay element is glass.

26. A system as set forth in claim 24 above, wherein the system provides passbands of selected frequencies in accordance with a selected ITU grid and the optical delay elements and the delay stage includes air length segments in each path, with the optical delay elements and air length segments in each path being interrelated to provide an athermal response to temperature variations over a selected range.

27. A system as set forth in claim 24 above, wherein the differential delay stage comprises delay elements of non-birefringent glass of different indices of refraction.

28. A system as set forth in claim 24 above, wherein the differential delay stage comprises a pair of glass elements serially disposed in one path and a single glass element disposed in the other.

29. A system as set forth in claim 24 above, wherein the input beam splitting polarizer divides the input into extraordinary and ordinary polarization beams for the two optical paths, and wherein the differential delay stage comprises polarization vector control means for phase tuning the transmission characteristics of the stage.

30. A system as set forth in claim 24 above, wherein at least one of the polarization beam splitters is angled relative to the beam direction to adjust the frequency period of the outputs.

31. A system as set forth in claim 24 above, wherein at least one of the differential delay stages includes an air delay line element.

32. A system as set forth in claim 31 above, wherein the differential delay stage comprises a first path having a non-birefringent glass element and a second path having a closed loop of reflecting elements providing a complete circuit of selected optical path length.

33. A system as set forth in claim 24 above, wherein the system further includes, in each beam path in association to the differential delay stage, elements imparting circular polarization to the beams, waveplate frequency adjusting means receiving the circularly polarized signals, and polarizing means receiving the frequency adjusted signals.

34. A microoptic element providing synthetic birefringence to apply a filtering function to an optical input beam comprising:
an input polarization beam splitter means receiving optical input beam and providing as outputs two differently polarized beams;
two signal delay paths, each comprising at least one non-birefringent optical element and receiving a different one of the differently polarized beams, the said non-birefringent elements having different selected indices of refraction and physical lengths accurate within ±1 micron of calculated lengths such that a precise relative retardation is introduced; and
an output polarization beam splitter receiving both beams and combining them.

35. A microoptic element as set forth in claim 34 above, wherein the difference in indices of refraction between the non-birefringent elements is greater than 15%, and wherein the non-birefringent elements are of glass and of substantially equal lengths between the two paths.

36. A microoptic element as set forth in claim 35 above, wherein the optical delays provide selected periodic bandpass functions in the optical input signals, and wherein the periodicity of the bandpass functions align the bandpass regions with respect to ITU grid standards.

37. A microoptic element as set forth in claim 36 above, wherein the indices of refraction are chosen such that the element has differential optical paths varying to less than 1 part in 10⁴ relative to a selected ITU grid periodicity, and the individual elements are of less than 20 mm in length.

38. A microoptic element as set forth in claim 37 above, wherein the signal delay paths comprise several stages each having at least one glass element, the first stage elements having a length L and disposed in a series of n elements, where n is an integer of 1 or greater, and succeeding stages having total lengths that are integer multiples of nL in length.

39. A microoptic element as set forth in claim 38 above, wherein the stages each include different glass elements selected to provide a passive athermal characteristic over a selected temperature range in each stage.

40. A microoptic element as set forth in claim 39 above, wherein the stages further include waveplate tuning elements for adjusting the periodicities of the outputs precisely to the ITU grid and the glass elements are 8-16 mm in length and the microoptic element is less than about 15 cm in total length.

41. A microoptic element as set forth in claim 40 above, wherein the output beam splitter comprises a first output beam splitter oriented to split each optical signal into two orthogonally polarized beams and a second output beam splitter orthogonally positioned relative to the first output beam splitter to recombine optical beam sets to polarization insensitive outputs.

42. A system for introducing a periodic transmissive function to an input optical beam of an arbitrary state of polarization having wavelength multiplexed channels comprising:
at least a first beam splitter arrangement receiving the optical beam and providing two beam pairs of different polarizations;
a pair of polarization insensitive optical delay lines, each in the path of a different beam, and introducing selected differential optical delays between beam pairs to provide wavelength dependent, polarization modulated beams carrying the multiplexed channels; and
at least a second beam splitter arrangement receiving the different beams from the delay lines and combining them to form a wavelength dependent, polarization modulated beams which transmit multiplexed channels of different spacings than the input.

43. A system as set forth in claim 42 above, wherein the optical delay lines comprise non-birefringent elements of substantially like physical lengths and different indices of refraction.

44. A system as set forth in claim 42 above, wherein the optical delay lines in the different paths are glass elements selected to have like optical path length changes with temperature.

45. A system as set forth in claim 44 above, wherein the glass elements are of lengths and refractive indices selected to compensate for thermal expansion and thermooptic effects along the two beam paths.

46. A system as set forth in claim 42 above, wherein the optical delay lines are arranged in at least two stages with integer related optical delay differential characteristics whose total differential optical lengths vary by integral multiples such that transmission passbands are shaped to selected characteristics.

47. A system as set forth in claim 42 above, wherein the system comprises in addition at least one additional stage of a pair of polarization insensitive optical delay lines in series with the first pair, input polarization management optics associated with the first beam splitter arrangement for launching a pair of identically polarized beams into the first optical delay line pair, and output polarization management optics associated with the second beam splitter arrangement for separating an identically polarized beam pair into alternate channels and combining them to provide polarization independent outputs.

48. A multistage optical signal interleaver providing periodically spaced passbands to one or more outputs from an input multiwavelength optical signal having an arbitrary state of polarization comprising:
a first polarization beam splitter combination receiving the input optical signal and providing two spaced apart, substantially parallel beam pairs, the beams of each pair being orthogonally polarized;
one or more stages of microoptic elements of non-birefringent characteristics, each receiving the beams from the first polarization beam splitter combination and configured with separate beam paths having selected differential optical retardation characteristics defining predetermined periodically spaced passbands, the outputs from the beam paths having selected polarizations;
a second polarization beam splitter combination receiving the outputs from the beam paths and combining differentially retarded beams from each of the two beam pairs to provide beams having wavelength dependent states of polarization; and a third polarization beam splitter combination receiving the beams from the second polarization beam splitter combination and combining the beams to form first and second output beams including first and second intensity modulated output beams having transmissive passbands at selected periodically spaced channels, the channels alternating between the output beams.

49. An interleaver as set forth in claim 48 above, wherein the orthogonally polarized beams received by the non-birefringent microoptic elements are linearly polarized.

50. An interleaver as set forth in claim 49 above, wherein the beams in the non-birefringent optical elements in each path are similarly polarized, but beams in the separate paths are orthogonally related with the orthogonality relationship being reversed between successive stages.

51. An interleaver as set forth in claim 48 above, wherein the orthogonally polarized beams received by the non-birefringent microoptic elements are circularly polarized to reduce back reflection and ripple.

52. An interleaver as set forth in claim 51 above, wherein the beams in the non-birefringent elements in one path are similarly circularly polarized, while beams in the other path are oppositely circularly polarized.

53. An interleaver as set forth in claim 48 above, wherein the interleaver further includes first ¼ or ¾ waveplate means disposed in association with at least one of the stages for converting beams of linear polarization to circular polarization, and half waveplate means disposed in the path of the beams of circular polarization for varying the relative phase between the two beams propagating along parallel paths.

54. An interleaver as set forth in claim 53 above, wherein the half waveplate means comprises a pair of serially disposed angularly adjustable half waveplates, each separately intercepting a different differentially retarded pair of beams from the separate beam paths, and the interleaver further includes a second ¼ or ¾ waveplate means after the half wavelength means for restoring the circular polarizations to linear polarizations.

55. A signal interleaver in accordance with claim 48, wherein the microoptic elements of the stages comprise non-birefringent glass elements of at least two different glasses of different indices of refraction in each of the different optical paths, the indices and lengths of the glass elements being chosen to provide selected optical path lengths in each stage that are passively athermal over a selected temperature range.

56. A signal interleaver in accordance with claim 55 above, wherein the stages are arranged with optical path lengths and relative angles of polarization of the beams to the microoptic elements selected to flatten the periodically spaced passbands, and increase channel isolation between passbands.

57. A signal interleaver in accordance with claim 55 above, wherein the beams in the glass elements comprise upper and lower pairs and the interleaver further includes waveplates disposed in the upper and lower beam paths for matching optical path lengths to minimize PMD.

58. A compact optical interleaving filter component for a WDM input beam comprising:
an input fiber optic collimator directing the input beam into the component;
an input polarization beam splitter receiving the collimated beam and producing two orthogonally polarized beams traveling along parallel paths;
an input waveplate array to convert the two orthogonally polarized beams into two beams of identical polarization;
an intermediate polarization beam splitter receiving the beams from the delay line elements and configured to separate each of the two beams of identical polarization into a pair of orthogonally polarized beams;
at least two microoptic delay line stages having parallel optical delay line elements of nominal difference D/ and 2D/ in optical path length, the stages being disposed in series and separately differentially delaying the pairs of orthogonally polarized beams without using intrinsic material birefringence, the delay line stages including polarization rotating elements disposed at angles selected to adjust the optical frequency transmissive characteristic imparted to the two different beam pairs independently of the differential delays, and by separately rotating the polarizations of two pairs of the beams to selected angles;
an output polarization beam splitter after the final one of the stages to recombine each of the two beams of a pair into a single different combined output beam; and
output optics receiving the one or more output beams and including folding optics and output collimators arranged to direct the one or more output beams into the one or more output fiber optic collimators.

59. An interleaving optical filter in accordance with claim 58, wherein the input waveplate array is oriented to minimize PMD by balancing the optical path lengths traversed by the two beams.

60. An interleaving optical filter in accordance with claim 58, wherein the total optical length difference D/ is equal to 12 mm for a 25 GHz interleaver.

61. An interleaving optical filter in accordance with claim 58 wherein the total optical path length difference D/ is equal to 6 mm for a 50 GHz interleaver.

62. An interleaving optical filter in accordance with claim 58, wherein the total optical path length difference D/ is equal to 3 mm for a 100 GHz interleaver.

63. An interleaving optical filter in accordance with claim 58, wherein the total optical path length difference DI is equal to 24 mm for a 12.5 GHz interleaver.

64. An interleaving optical filter in accordance with claim 58, wherein the polarization rotating elements are half waveplates which are disposed between the first and second interleaver stages at angles of −31.0±1 degrees and between the second and third interleaver stages at angles of 13.1±1 degrees.

65. A multistage optical signal interleaver for demultiplexing DWDM channels at a single beam terminal into odd and even output channels at second and third beam terminals or alternatively multiplexing odd and even input channels at the second and third terminals into a composite output beam at the first beam terminal comprising:
a first polarization beam splitter combination having a first terminal coupled to the single beam terminal and a pair of spaced apart beam terminals separate from the first terminal;
at least two stages of non-birefringent microoptic elements disposed serially along a beam delay path, each stage including separate beam paths having selected optical path length characteristics providing a chosen differential retardation between beams on the different paths, one serial terminus of the stages being in communication with the pair of terminals of the first polarization beam splitter, the other serial terminus providing a pair of beam ports;
an additional polarization beam splitter coupled optically between the pair of beam ports and the second and third terminals.

66. An interleaver as set forth in claim 65 above, wherein each stage includes polarization beam splitter means arranged to direct at least two beam pairs through the stages, and each beam delay path includes a waveplate combination for phase tuning to selected channel placements.

67. An interleaver as set forth in claim 66 above, wherein the non-birefringent optical elements comprise glass elements substantially of basic length L, and wherein channel spacing is defined by serial disposition in the stages of integer multiples of elements of the basic length and frequency period is adjusted by angling at least on polarization beam splitter.

68. An interleaver as set forth in claim 64 above, wherein the stages comprise three stages of total lengths L, 2L and 2L for a 50 GHz interleaver, where n is a length selected for a 100 GHz interleaver.

69. An interleaver as set forth in claim 64 above, wherein the stages comprise two stages of nominal total lengths 2L and 4L for a 25 GHz interleaver, where n is a length selected for a 100 GHz interleaver.

70. An interleaver as set forth in claim 64 above, wherein the stages comprise two stages of nominal total lengths 4L and 8L for a 12.5 GHz interleaver, where n is a length selected for a 100 GHz interleaver.

71. A method of providing an interleaved optical frequency response for filtering WDM channels carried by a polarized or unpolarized optical beam comprising the steps of:
splitting the input beam into linearly and orthogonally polarized beams spaced apart in a first direction;
rotating the state of polarization of at least one of the beams so they become identically polarized;
rotating the states of polarization of both beams by a first angle;
splitting each of the beams in a second direction orthogonal to the first while introducing an orthogonal polarization relationship therebetween;
applying different phase delays to beam pairs separated in the second direction while leaving the states of polarization unchanged;
separately phase tuning the beam pairs separated in the first direction to adjust the absolute frequency of transmissive peaks in passage along the beam paths;
tuning the frequency period of the transmissive peaks separately from the phase tuning;
combining each pair of beams in the second direction to produce two periodic, wavelength dependent state of polarization beams with first optical frequency and phase;
rotating the states of polarization of each of the combined beams by a second angle;
repeating at least once the sequence from splitting the beams to producing periodic, wavelength dependent, states of polarization beams having selected optical frequency and phase, while converting the last pair of periodic, wavelength dependent states of polarization to a pair of output beams with wavelength dependent intensities which are in independent of polarization.

72. A method as set forth in claim 71 above, wherein the step of applying different phase delays to beam pairs is effected with the orthogonal beams being circularly polarized.

73. A method as set forth in claim 71 above, wherein the step of phase tuning is employed in all but the last of the repeated sequences.

74. A method as set forth in claim 71 above, further including the steps of converting the beams from linear to circular polarizations prior to phase tuning, and converting circularly polarized beams to linearly polarized beams prior to combining each pair of beams separated in the first direction.

75. A method as set forth in claim 71 above, wherein the beams are converted to circular polarizations in opposite senses of circularity prior to applying different independent phase delays and converted back to linear polarizations after phase tuning.

76. A method as set forth in claim 71 above, wherein the step of tuning the frequency period is effected while splitting beams.

77. A method as set forth in claim 71 above, wherein the steps of applying different independent yet integer related phase delays are arranged to provide at least two successively narrower channel spacings whose channel spacings match the channel frequencies in the ITU grid.

78. A method of providing an interleaved optical frequency response for filtering DWDM channels carried by a polarized or an unpolarized beam utilizing a polarization interference filter with a polarization reference frame in which 0 degrees is defined as vertical and positive angles are defined as clockwise, comprising the steps of;
splitting the input beam into linearly and orthogonally polarized upper and lower beams;
rotating the state of polarization of the upper beam by 90 degrees so both upper and lower beams become identically polarized;
rotating the states of polarization of both upper and lower beams by a first angle;
splitting each of the upper and lower beams into a left beam linearly polarized at 0 degrees and a right beam linearly polarized at 90 degrees;
applying a first wavelength dependent and polarization independent phase delay to the left beams while leaving the states of polarization unchanged;
applying a second wavelength dependent and polarization independent phase delay to the right beams while leaving the states of polarization unchanged, the first and second phase delays having a selected differential value;
converting the states of polarization of the left beams and right beams to circularly polarized light;
applying a first wavelength independent phase delay to the upper beams while preserving the circular state of polarization;
applying a second wavelength independent phase delay to the lower beams while preserving the circular state of polarization;
converting the state of polarization of the left beams to a linear state of polarization at 90 degrees and the right beams to a linear state of polarization at 0 degrees;
combining the lower right and left beams into a single lower beam to produce a periodic, wavelength dependent state of polarization with first optical frequency period and phase combining the upper right and left beams into a single upper beam to produce the same periodic, wavelength dependent state of polarization with first optical frequency period and phase,
rotating the states of polarization of both upper and lower beams by a second angle;
splitting each of the upper and lower beams into a left beam linearly polarized at 0 degrees and a right beam linearly polarized at 90 degrees;
applying a third wavelength dependent and polarization independent phase delay to the left beams while leaving the states of polarization unchanged;
applying a fourth wavelength dependent and polarization independent phase delay to the right beams while leaving the states of polarization unchanged, the third and fourth phase delays having a selected differential value;
converting the states of polarization of the left beams and right beams to circularly polarized light;
applying a third wavelength independent phase delay to the upper beams while preserving the circular states of polarization;
applying a fourth wavelength independent phase delay to the lower beams while preserving the circular states of polarization;
converting the states of polarization of the left beams to a linear state of polarization at 90 degrees and the right beams to a linear state of polarization at 0 degrees;
combining the lower right and left beams into a single beam to produce a periodic, wavelength dependent state of polarization with a second optical frequency period and phase having a selected relation to the first optical frequency period and phase;
combining the upper right and left beams into a single beam to produce a corresponding periodic, wavelength dependent state of polarization having the second optical frequency period and phase,
rotating the states of polarization of both upper and lower beams by a third angle;
splitting the upper and lower beams into a left beam linearly polarized at 0 degrees and a right beam linearly polarized at 90 degrees;
applying a fifth wavelength dependent and polarization independent phase delay to the left beams while leaving the states of polarization unchanged;
applying a sixth wavelength dependent and polarization independent phase delay to the right beams while leaving the states of polarization unchanged, the fifth and sixth phase delays having a selected differential value;
converting the states of polarization of the left beams and right beams to circularly polarized light;
applying a fifth wavelength independent phase delay to the upper beams while preserving the circular states of polarization;
applying a sixth wavelength independent phase delay to the lower beams while preserving the circular states of polarization;
converting the states of polarization of the left beams to a linear state of polarization at 90 degrees and the right beams to a linear state of polarization at 0 degrees;
combining the lower right and left beams into a single beam to produce a periodic, wavelength dependent state of polarization with second optical frequency period and phase;
combining the upper right and left beams into a single beam to produce the same periodic, wavelength dependent state of polarization with second optical frequency period and phase;
rotating the states of polarization of upper and lower beams by a fourth angle;
splitting the upper and lower beams into a left beam linearly polarized at 0 degrees and a right beam linearly polarized at 90 degrees;
rotating the states of polarization of the upper left and lower right beams by 90 degrees;
recombining the left beams into a single first output beam with periodic, frequency dependent transmission, and
recombining the right beams into a single second output beam with periodic, frequency dependent transmission, wherein the first output beam and second output beam exhibit polarization independence.

79. A method in accordance with claim 78 above, wherein the first angle is about 45.0°, the second angle is about 62.0°, the third angle is about 26.2°, the fourth angle is about 9.2°, the first optical frequency period is 100.00 GHz, the second optical frequency period is 50.00 GHz, and all the phases are selected to align the interleaver frequency responsively to the ITU grid.

80. A method in accordance with claim 78 above, wherein the first angle is about 45.0°, the second angle is about 62.0°, the third angle is about 26.2°, the fourth angle is about 9.2 ° degrees, the first optical frequency period is 200.00 GHz, the second optical frequency period is 100.00 GHz, and all the phases are selected to align the interleaver frequency response to the ITU grid.

81. A method in accordance with claim 78 above, including a final step of decoding wavelength dependent polarization modulation into wavelength dependent intensity modulation.

82. A method of providing an interleaved optical frequency response for filtering DWDM channels carried by a polarized or an unpolarized beam utilizing a polarization interference filter with a polarization reference frame in which 0 degrees is defined as vertical and positive angles are defined as clockwise is defined, comprising the steps of;
splitting the input beam into linearly and orthogonally polarized upper and lower beams;
rotating the state of polarization of upper beam by 90 degrees so both upper and lower beams become identically polarized;
rotating the states of polarization of both the upper and lower beams by a first angle;
splitting each of the upper and lower beams into a left beam linearly polarized at 0 degrees and a right beam linearly polarized at 90 degrees;
applying a first wavelength dependent and polarization independent phase delay to the left beams while leaving the states of polarization unchanged;
applying a second wavelength dependent and polarization independent phase delay to the right beams while leaving the states of polarization unchanged, the first and second phase delays having a selected differential value;
converting the state of polarization of the left beams to a linear state of polarization at 90 degrees and the right beams to a linear state of polarization at 0 degrees;
combining the lower right and left beams into a single lower beam to produce a periodic, wavelength dependent state of polarization with first optical frequency period and phase
combining the upper right and left beams into a single upper beam to produce the same periodic, wavelength dependent state of polarization with first optical frequency period and phase;
rotating the states of polarization of both upper and lower beams by a second angle;
splitting each of the upper and lower beams into a left beam linearly polarized at 0 degrees and a right beam linearly polarized at 90 degrees;
applying a third wavelength dependent phase delay to the left beams while leaving the states of polarization unchanged;
applying a fourth wavelength dependent and polarization independent phase delay to the right beams while leaving the states of polarization unchanged the third and fourth phase delays having a selected differential value;
converting the states of polarization of the left beams to a linear state of polarization at 90 degrees and the right beams to a linear state of polarization at 0 degrees;
combining the lower right and left beams into a single beam to produce a periodic, wavelength dependent state of polarization with second optical frequency period and phase having a selected rotation to the first optical frequency period and phase;
combining the upper right and left beams into a single beam to produce a corresponding periodic, wavelength dependent state of polarization having the second optical frequency period and phase,
rotating the states of polarization of both upper and lower beams by a third angle;
splitting the upper and lower beams into a left beam linearly polarized at 0 degrees and a right beam linearly polarized at 90 degrees;
applying a fifth wavelength dependent and polarization independent phase delay to the left beams while leaving the states of polarization unchanged;
applying a sixth wavelength dependent and polarization independent phase delay to the right beams while leaving the states of polarization unchanged the fifth and sixth phase delays having a selected differential value;
converting the states of polarization of the left beams to a linear state of polarization at 90 degrees and the right beams to a linear state of polarization at 0 degrees;
combining the lower right and left beams into a single beam to produce a periodic, wavelength dependent state of polarization with second optical frequency period and phase;
combining the upper right and left beams into a single beam to produce the same periodic, wavelength dependent state of polarization with second optical frequency period and phase;
rotating the states of polarization of upper and lower beams by a fourth angle;
splitting the upper and lower beams into a left beam linearly polarized at 0 degrees and a right beam linearly polarized at 90 degrees;
rotating the states of polarization of the upper left and lower right beams by 90 degrees;
recombining the left beams into a single first output beam with periodic, frequency dependent transmission, and
recombining the right beams into a single second output beam with periodic, frequency dependent transmission, wherein the first output beam and second output beam exhibit polarization independence.

83. The method of interleaving different frequency channels existing in a multiwavelength multiplexed optical input beam, while transmissively filtering the frequencies relative to target frequencies, comprising the steps of:
dividing the input beam into first and second optical beam pairs, the beams of each pair being orthogonally and linearly polarized;
differentially retarding the two beams within each pair by propagating them through polarization insensitive media;
differentially phase delaying beams of individual pairs to adjust transmissive peaks of each pair to target frequencies;
separately combining orthogonally polarized individual beams of each pair into single beams to produce two beams of periodic, wavelength dependent states of polarization of first optical frequency and phase.

84. The method of claim 83 above, further comprising the additional steps of again separating the two beams into pairs of beams of orthogonal and linear polarization;
and recombining the orthogonally polarized beams in each pair separately to provide first and second intensity modulated, periodic, frequency dependent transmissions spaced relative to the target frequencies.

85. The method of interleaving different frequency channels existing in a multiwavelength multiplexed optical signal, while transmissively filtering the frequencies relative to target frequencies, comprising the steps of:
separating the multiplexed optical signal into first and second input beams of identical polarization;
dividing the input beams into pairs with beams of orthogonal polarization;
differentially retarding beam pairs along separate optical paths;
separately combining individual beams adjacent from the two pairs to produced periodic, wavelength dependent states of polarization of first optical frequency and phase;
re-separating the two beams into pairs of beams of orthogonal polarization;
repeating the sequence of dividing the combined beams, differentially retarding, combining to produce additional optical transmission responses with periodic, wavelength dependent states of polarization with optical frequencies and phases selectively related to the first optical frequency and phase and re-separating into pairs of beams; and
after the last such sequence, transferring and directing the beams in each pair separately to produce two output beams with first and second intensity modulated, periodic, frequency dependent transmission.

86. The method as set forth in claim 85 above, including the further step of phase adjusting transmissive peaks by introducing phase delays between each pair of beams of orthogonal polarization.

87. The method as set forth in claim 85 above, wherein the steps of differentially retarding further comprise maintaining the differential retardation substantially constant over a selected temperature range, and flattening the transmission peaks while increasing the rejection between the transmissive peaks.

88. The method as set forth in claim 85 above, including the further step of adjusting the frequency period while dividing or combining the beams.

89. The method of filtering a multiwavelength optical signal with an approximation of a square wave transmittance function matched to ITU wavelengths while separating the optical signal into two multiwavelength optical signals of like periodicities but offset in wavelength, comprising the steps of:
polarization splitting the optical beam into four different beams polarized orthogonally in two different pairs;
directing each pair of component beams through different polarization insensitive optical paths, the different paths having selected optical path length differences to synthesize birefringent delays;
converting the four beams to circular polarization;
applying differential retardation to the circularly polarized beams;
converting the four beams back to linear polarization states with polarizations rotated 90° in each pair from the original pairs; and
polarization combining the converted beams to provide two outputs whose states of polarization are wavelength dependent.

90. The method as set forth in 89 above, wherein the step of providing two outputs comprises providing separate outputs having transmissive peaks at double the periodicity of the original signal, with peaks from the two signals alternating in frequency.

91. A method of introducing a predetermined periodic transfer function in a multiwavelength optical beam comprising the steps of:
dividing the optical beams into two input beams of like state of polarization;
directing the beams separately through a series of stages, each of which include separate non-birefringent optical path segments which introduce predetermined optical path length differences that are substantially constant over a selected temperature range, such that after each stage the beams possess frequency varying transfer functions derived from the optical path length differences of the stages, wherein the transfer functions of the individual stages have integer related frequency periodicities at precise phase relationships;
separating the beams into four components; and
combining the four components into two polarization independent output beams having complementary, frequency periodic transfer functions.

92. The method as set forth in claim 91 above, wherein the phase relationships between the stages have relative phases of either 0° or 180°.

93. The method as set forth in claim 91 above, wherein the non-birefringent optical path segments are non-birefringent and arranged in pairs, with the lengths, refractive indices and thermooptic properties related to provide the desired athermal characteristic.

94. The method as set forth in claim 91 above, wherein the non-birefringent path segments comprise delay lines of different optical path lengths.

95. The method as set forth in claim 91 above, wherein the step of directing the beams separately through a series of stages include equalizing the lengths of the paths between the non-birefringent optical path segments.

96. The method of utilizing polarization interference to introduce a periodic frequency and interleaved response to DWDM optical signals in an input beam, comprising the steps of:
splitting the input beam into orthogonally polarized first and second beams;
rotating at least one of the first and second beams to states of identical polarization at a selected first angle;
splitting the first and second beams to provide displaced third and fourth beams that are polarized at orthogonal relationships to the non-displaced residual first and second beams;
applying different wavelength dependent retardation delays to the first and second beams than the third and fourth beams by propagation through paths having selectively different optical path lengths;
converting the states of polarization of the beams to circular polarization along the beam path lengths;
preserving the circular polarizations while phase tuning the different beam pairs;
converting the first, second, third and fourth beams, respectively, to linearly polarized and orthogonal states, the directions being 90° different from the directions of polarization immediately prior to retardation delays;
combining the first and third beams, respectively, and the second and fourth beams, respectively, to provide individual beams having periodic, wavelength dependent states of polarization, and
deriving intensity modulated output signals having frequency dependent transmission characteristics.

97. The method as set forth in claim 96 above, further including the step of repeating at least once the sequence of steps including the splitting of beams, applying different retardation delays, and introducing different phase tuning.

98. The method as set forth in claim 95 above, wherein the step of phase tuning is performed in association with the application of differential delays.

99. The method as set forth in claim 95 above, wherein the step of phase tuning is performed independently of the application of differential delays.

100. In an optical signal interleaver employing at least one birefringent polarization beam splitter and at least one differential delay stage for providing, by interferometric operation, transmittance passbands centered on frequencies in an ITU grid, the method comprising the steps of:
directing an optical beam having multiple frequency components through the at least one polarization beam splitter into the differential delay stage, and
varying the angle of the beam relative to the at least one polarization beam splitter to adjust the frequency period of the transmittance passbands derived from the at least one stage.

101. In an optical signal interleaver in which differential delays in optical elements are employed to derive, from wavelength division multiplexed input signals, output signals in a different multiplexed format that have frequencies aligned with standards in an ITU grid, the method comprising the steps of:
in association with the optical elements, providing at least two beam components subject to the differential delay;
generating circular stages of polarization in the at least two beam components, and
separately adjusting the polarization vectors of the at least two beam components to vary the phases of the beams such that the output signals match the frequencies of the ITU grid.

102. A method in accordance with claim 100 above, wherein the interleaver generates two beam pairs, to be differentially delayed, the beams of each pair being displaced from each other but also paired individually with a different beam form the other pair, wherein the method further comprises the step of separately adjusting the angles of the polarization vectors for the individually paired beams from the two different beam pairs.

103. An interleaver device for optical signal communications, comprising:
a planar surface bench structure having an array of mounting pads disposed along a longitudinal axis along the plane of the surface;
at least two differential retardation stages in series and each comprising glass elements mounted on the pads along the longitudinal axis, the glass elements being elongated rectangular elements with their axis of elongation parallel to the longitudinal axis, the glass elements of each stage being arranged in side by side relation to provide two separate beam paths for differential retardation, with close longitudinal abutment of glass elements serially disposed in any individual stage;
at least one waveplate combination disposed between each successive pair of stages for adjusting phase relationships;
at least two polarization beam splitters disposed along the longitudinal axis, the polarization beam splitters being positioned to selectively divide and/or combine beams between the stages, dependent on beam direction;
a single optical waveguide coupled to one end of the series of retardation stages;
a separate pair of optical waveguides coupled to the series of retardation stages at the opposite end thereof; and
a pair of polarization beam splitters serially disposed along the longitudinal axis between the said opposite end of the stages and the pair of waveguides.

104. An interleaver device as set forth in claim 103 above, for bi-directional operation as either a multiplexer or demultiplexer, wherein the glass elements are arranged in the stages to have unlike optical path lengths for each of the two beam paths and wherein the stages each have an integer number of glass elements arranged in series in each of the two separate paths.

105. An interleaver device as set forth in claim 104 above, wherein the device further comprises a beam collimator disposed between the beam path and the optical waveguide at the one end, and an optical combination at said opposite end comprising at least two polarizing beam splitters disposed in series, separate folding optics for redirecting the two beams and beam collimators communicating beams individually to the pair of optical waveguides.

106. A waveplate combination for a multistage optical interleaver having target transmission peaks for a wavelength multiplexed signal, each stage of the interleaver generating differential retardance for first and second pairs of optical beams of orthogonal polarization comprising:
a first quarter waveplate oriented at plus or minus 45°0 to the polarization axis of the optical beams;
a first half waveplate disposed in the paths of the first two optical beams and adjacent the quarter waveplate, and rotatable with respect to the polarization axis to adjust the absolute frequencies of the interleaver transmission peaks to match the target peaks;
a second half waveplate disposed in the paths of the remaining two optical beams and adjacent the quarter waveplate and rotatable with respect to the polarization axis to adjust the absolute frequencies of the interleaver transmission peaks to match the target peaks; and
a second quarter waveplate oriented at minus 90° to the first quarter waveplate to convert the first and second pairs of optical beams to linear states of polarization.

107. A waveplate combination as set forth in claim 102 above, wherein the optical beams generating differential retardance comprise four parallel beams in quadrants arranged as two pairs, each with orthogonal polarizations.

108. A waveplate combination as set forth in claim 107 above, wherein the first quarter waveplate converts the orthogonally polarized beams to circular states of polarization.

109. An interleaver optical filter component dividing an input multi-wavelength beam into interleaved multiple even channels and multiple odd channels and including separate retardation stages, the polarization rotators being configured to provide beam angles into the retardation stages such that the desired optical transmission response is synthesized.

110. An interleaver optical filter component in accordance with claim 109 above, wherein the polarization rotators comprise input waveplates arranged to rotate the polarizations of both beams to selected angles before entering the filtering stages such that even channels exhibit approximately quadratic group delay characteristics of opposite sign to the odd channels.

111. An interleaver optical filter component in accordance with claim 109 above wherein the retardation stages exhibit relative phases configured such that the even channels exhibit approximately quadratic group delay characteristics of opposite sign to the odd channels.

112. An interleaving optical filter arrangement in accordance with claim 109 wherein a compensating pair of interleaver optical filter components are disposed in the channels and configured to operate in series combination to provide zero chromatic dispersion in transmission through the pair.

113. An interleaving optical filter in accordance with claim 97 wherein the filtering stages consist of synthetic birefringent elements utilizing two glass delay line elements, wherein the glass elements are of nominally equal lengths and exhibit compensating temperature dependencies such that the optical frequency periodicity of the interleaver drifts by less than +/−1.5 GHz over the operating temperature range of 0 to 70° C.
